(19) United States
(12) Patent Application Publication
(10) Pub. No.: US 2017/0115745 A1
(43) Pub. Date: Apr. 27, 2017

(54) SHAPE-CHANGING KEYBOARD

(71) Applicant: EMPIRE TECHNOLOGY DEVELOPMENT LLC, Wilmington, DE (US)

(72) Inventor: Noam HADAS, Tel-Aviv (IL)

(73) Assignee: EMPIRE TECHNOLOGY DEVELOPMENT LLC, Wilmington, DE (US)

(21) Appl. No.: 15/301,708

(22) PCT Filed: Apr. 11, 2014
(86) PCT No.: PCT/US14/33857

§ 371 Date: Oct. 3, 2016

(51) Int. Cl. G06F 3/02

(52) U.S. Cl. CPC G06F 3/0216; G06F 3/0208

(57) ABSTRACT

In some examples, a shape-changing keyboard includes a first segment, a second segment, and a dynamic adjustment assembly. The dynamic adjustment assembly may be coupled between the first and second segments. The dynamic adjustment assembly may be configured to change the shape-changing keyboard from a first state to a second state by change over time of a position and/or orientation of at least a portion of one or both of the first and second segments. The second state may be a more ergonomic state than the first state.

### BACKGROUND

Unless otherwise indicated herein, the materials described herein are not prior art to the claims in the present application and are not admitted to be prior art by inclusion in this section.

Some standard QWERTY keyboards force a user's hands into unnatural postures for prolonged periods, which can result in pain, discomfort, limitations on length of use, and even repetitive stress injuries such as carpal tunnel syndrome. Numerous ergonomic keyboards of various designs attempt to limit or totally prevent such problems. However, ergonomic keyboards have not been widely adopted.

One reason ergonomic keyboards have not been widely adopted may be that adoption by users of such keyboards may involve a period during which their typing speed and typing accuracy may be reduced until they have adapted to the ergonomic keyboards. In addition, users may experience pain until they become more accustomed to ergonomic keyboards. Keyboard users with relatively heavier keyboard use may be the most likely to experience long-term benefits from switching to an ergonomic keyboard, but the potentially negative short-term effects of pain, reduced typing speed, and/or reduced typing accuracy may discourage them from switching to an ergonomic keyboard.

### SUMMARY

Technologies described herein generally relate to a shape-changing keyboard.

In some examples, a shape-changing keyboard may include a first segment, a second segment, and a dynamic adjustment assembly. The dynamic adjustment assembly may be coupled between the first and second segments. The dynamic adjustment assembly may be configured to change the shape-changing keyboard from a first state to a second state by change over time of a position and/or orientation of at least a portion of one or both of the first and second segments. The second state may be a more ergonomic state than the first state.

In some examples, a method to transition a shape-changing keyboard from a first state to a second state that is a more ergonomic state than the first state is described. Various methods may include repeatedly identifying a trigger event when the shape-changing keyboard is in a preceding state, where the shape-changing keyboard includes a first segment and a second segment. Some methods may also include, in response to the trigger event, repeatedly dynamically changing the shape-changing keyboard from the preceding state to a subsequent state. Repeatedly identifying the trigger event when the shape-changing keyboard is in the preceding state and repeatedly dynamically changing the shape-changing keyboard from the preceding state to the subsequent state may be effective to change the shape-changing keyboard over time. For example, the shape-changing keyboard may be changed over time from the first state to the second state. Repeatedly dynamically changing the shape-changing keyboard from the preceding state to the subsequent state may include effecting a change over time of a position and/or orientation of at least a portion of one or both of the first and second segments.

In some examples, a non-transitory computer-readable medium is described. Various example non-transitory computer-readable mediums may have stored thereon computer-readable instructions, which in response to execution by a processing device, cause the processing device to perform or control performance of operations to transition a shape-changing keyboard from a first state to a second state that is a more ergonomic state than the first state. Some operations may include repeatedly identifying a trigger event when the shape-changing keyboard is in a preceding state and wherein the shape-changing keyboard includes a first segment and a second segment. The operations may also include, in response to the trigger event, repeatedly dynamically changing the shape-changing keyboard from the preceding state to a subsequent state. Repeatedly identifying the trigger event when the shape-changing keyboard is in the preceding state and repeatedly dynamically changing the shape-changing keyboard from the preceding state to the subsequent state may be effective to change the shape-changing keyboard over time. For example, the shape-changing keyboard may be changed over time from the first state to the second state. Repeatedly dynamically changing the shape-changing keyboard from the preceding state to the subsequent state may include effecting a change over time of a position and/or orientation of at least a portion of one or both of the first and second segments.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

In the drawings:

FIGS. 1A and 1B illustrate left and right hands of a user during use of a keyboard having a relatively less ergonomic or non-ergonomic state;

FIG. 2 is a block diagram of an example device configured to adjust between a first state and a second state;

FIGS. 3A-3E include various views of an example embodiment of a shape-changing keyboard;

FIGS. 4A-4C include various partially exploded perspective views of an example embodiment of the keyboard of FIGS. 3A-3E;

FIG. 5A shows a flow diagram of an example method to transition a shape-changing keyboard from a first state to a second state;

FIG. 5B shows a flow diagram of another example method to transition a shape-changing keyboard from a first state to a second state; and

FIG. 6 is a block diagram illustrating an example computing device that is arranged to transition a device from a first state to a second state, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

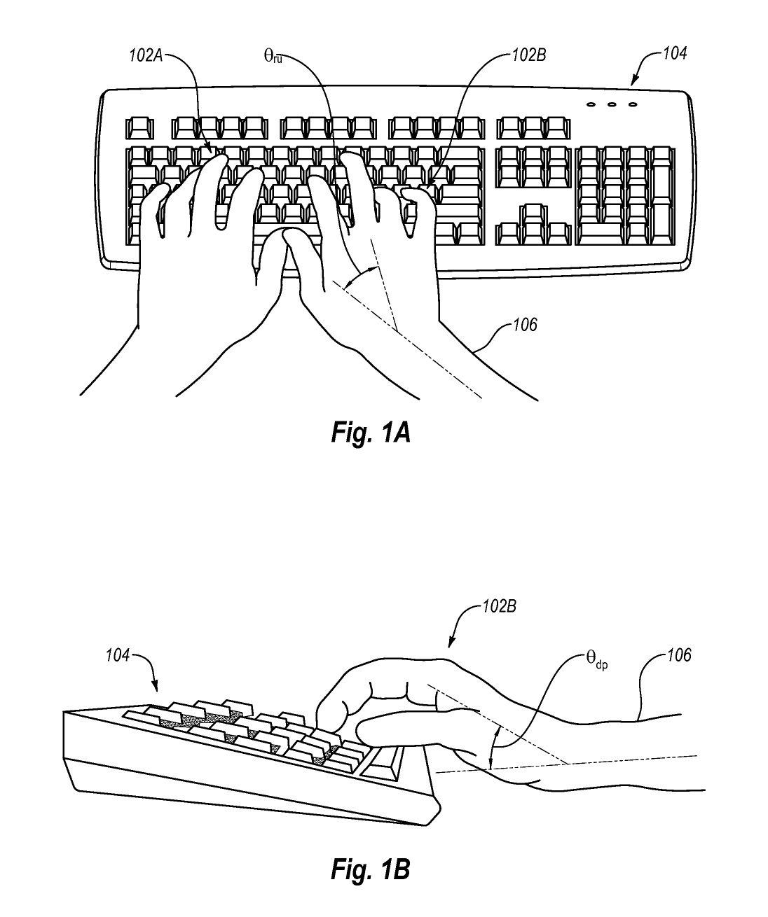

FIGS. 1A and 1B illustrate left and right hands 102A and 102B (collectively “hands 102”) of a user (not shown) during use of a keyboard 104 having a relatively less ergonomic or non-ergonomic state, arranged in accordance with at least some embodiments described herein. The keyboard 104 may additionally include a relatively more ergonomic state and may be adjustable between the illustrated less ergonomic or non-ergonomic state of FIGS. 1A and 1B and the more ergonomic state as described in more detail below.

More generally, the keyboard 104 may include a first state and a second state, where the second state may be a more ergonomic state than the first state. For example, the first state may include the non-ergonomic or less ergonomic state, while the second state may include the more ergonomic state or an ergonomic state. In the discussion of FIGS. 1A and 1B that follows, the first state of the keyboard 104 may be described as the non-ergonomic state while the second state of the keyboard 104 may be described as the ergonomic state.

FIGS. 1A and 1B additionally illustrate various parameters associated with the use of the keyboard 104. The parameters are discussed in terms of the right hand 102B with the understanding that the parameters may also be applied to the left hand 102A. Referring to FIG. 1A, the right hand 102B may be arranged at a radioulnar angle θᵣᵤ relative to a right forearm 106 of the user. The radioulnar angle θᵣᵤ may vary depending on the user's position (e.g., upper body position relative to hands) and orientation with respect to the keyboard 104, among potentially other factors. In keyboards arranged in a non-ergonomic state, however, the radioulnar angle θᵣᵤ may typically be similar to that illustrated in FIG. 1A in which the hands 102 are each bent at the wrist towards the corresponding ulna.

Referring to FIG. 1B, the right hand 102B may alternately or additionally be arranged at a dorsopalmar angle θ_{dp} relative to the right forearm 106 of the user. The dorsopalmar angle θᵣᵤ may vary depending on the user's position and orientation with respect to the keyboard 104 and a tilt of the keyboard, among potentially other factors. In keyboards arranged in a non-ergonomic state, however, the dorsopalmar angle θ_{dp} may be similar to that illustrated in FIG. 1B in which both hands 102 (only the right hand 102B is shown in FIG. 1B) are bent upward at the wrist.

Prolonged typing at radioulnar angles θᵣᵤ and/or dorsopalmar angles θ_{dp} such as illustrated in FIGS. 1A and 1B may create contact stress to the tendon sheath and tendons that move within the wrists of the user. Radioulnar angles θᵣᵤ and/or dorsopalmar angles θ_{dp} equal to or substantially equal to zero may reduce or substantially eliminate contact stress to the tendon sheath. Ergonomic keyboards and/or shape-changing keyboards with an ergonomic state may have a layout configured to reduce or substantially eliminate contact stress by, e.g., adjusting the radioulnar angle θᵣᵤ and/or the dorsopalmar angle θ_{dp}.

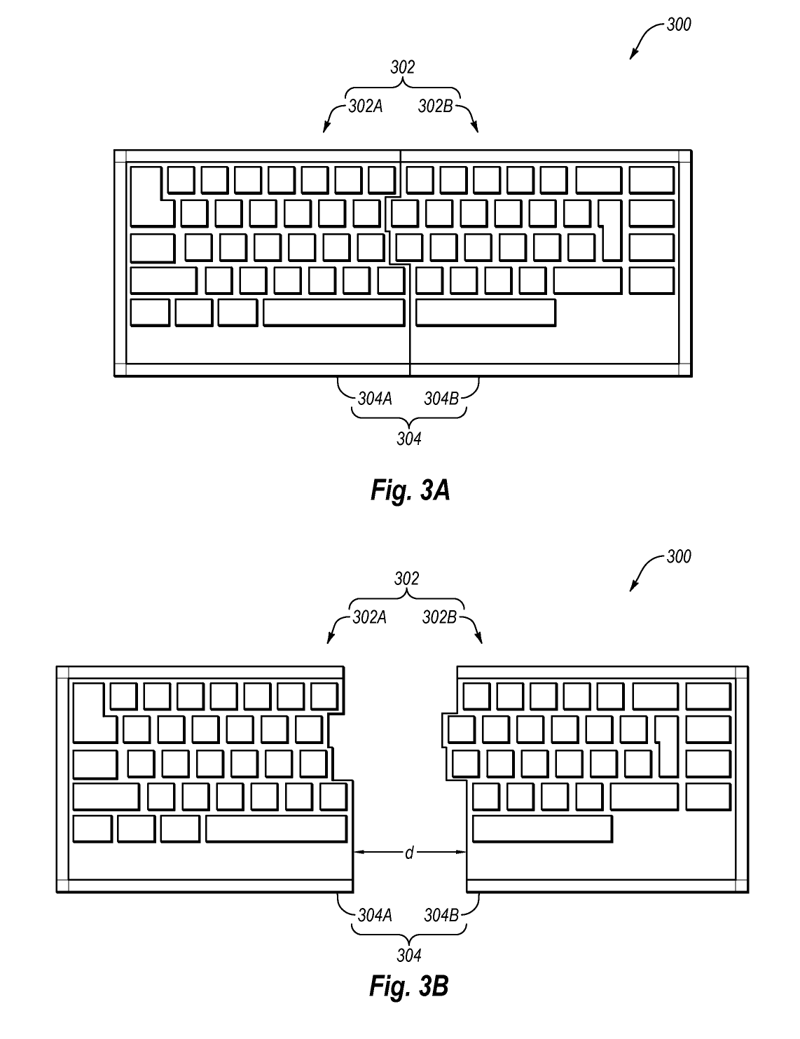

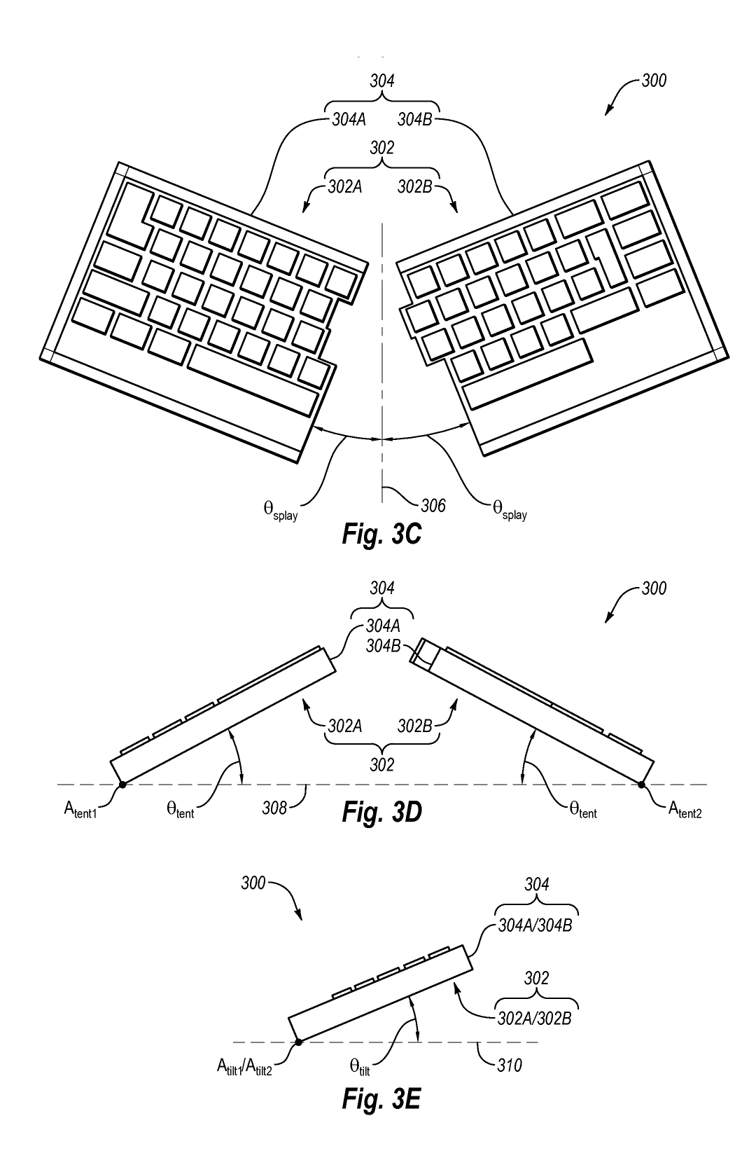

Some embodiments described herein relate to a shape-changing keyboard with a first state and a second state that is a more ergonomic state than the first state. The shape-changing keyboard may include a first segment and a second segment. In the first state, such as an initial non-ergonomic state, the shape-changing keyboard including the first and second segments may be configured substantially as illustrated in FIGS. 1A and 1B, for example. The first state may include a state that is recognizable and/or familiar to users and/or that may be readily acceptable by users as a starting point for subsequent changes to the second state that is more ergonomic than the first state. In contrast, in the second state and compared to the first state, the positions and/or orientations of the first and second segments may be different. For instance, in the first state, a separation distance (see FIG. 3B) between the two segments, a tilt angle (see FIG. 3E) of each segment, a splay angle (see FIG. 3C) of each segment, and/or a tent angle (see FIG. 3D) of each segment may have initial values that may be different in the second state.

The shape-changing keyboard may additionally include a dynamic adjustment assembly coupled between the first and second segments. The dynamic adjustment assembly may include, for instance, one or more electric motors and various other components as described in more detail herein. The dynamic adjustment assembly may operate responsive to control signals received from a processor device. The processor device may be included in the shape-changing keyboard. Alternately or additionally, the processor device may be included in a computer to which the shape-changing keyboard is communicatively coupled.

The dynamic adjustment assembly may be configured to change the shape-changing keyboard from the first state to the second state by change over time of the position and/or orientation of one or both of the first and second segments. The change(s) may be automatic in some embodiments. The second state may include a default ergonomic state or a user-specific ergonomic state optimized or customized for a user of the shape-changing keyboard. The change over time (automatic or otherwise) may include multiple incremental changes with an adaptation period between each incremental change. The adaptation period may be fixed and may be sufficient to allow at least some users to adapt to the incremental change before a subsequent incremental change is implemented. The adaptation period may be measured in use time as a measure of the amount of time in which the shape-changing keyboard is in use, may be measured in real time as a measure of the total amount of time (whether the shape-changing keyboard is in use or not) since a prior incremental change, or in another suitable manner.

Alternately or additionally, the adaptation period may depend on a performance parameter such as typing accuracy and/or typing speed. In these and other embodiments, the adaptation period may end and a subsequent incremental change may be implemented after the performance parameter satisfies a performance threshold.

In some embodiments, each incremental change may be relatively small in magnitude. By making relatively small incremental changes and waiting to make a subsequent incremental change until a user has sufficiently adapted to a previous incremental change, the embodiments described herein may provide an almost unnoticeable adaptation process between non-ergonomic and ergonomic states. It may be inferred that the user has sufficiently adapted based on passage of a fixed adaptation period (e.g., as measured in use time or real time) such as generally described herein. Alternately or additionally, it may be determined that the user has sufficiently adapted based on a performance parameter satisfying a performance threshold as generally described herein. In these and/or other embodiments, a user may transition from a first state to a second state that is a more ergonomic state than the first state relatively slowly over time via multiple intermediate states associated with the incremental changes. Alternately or additionally, the user may transition from the first state to the second state relatively slowly over time The transition via multiple intermediate states may substantially avoid the pain, reduced typing speed, reduced typing accuracy, and/or other potential negative effects of switching directly from a non-ergonomic keyboard to an ergonomic keyboard. For example, the shape-changing keyboard may take a week or more to incrementally transition from the first or initial non-ergonomic state to the second or ergonomic state.

Alternately or additionally, the user may transition from the first state to the second state relatively slowly over time via a slow continuous change from the first state to the second state. For example, where the dynamic adjustment assembly includes an electric motor to effect changes in position and/or orientation to one or both of the first or second segments, the transition from the first state to the second state may be effected in a slow and continuous manner by operating the electric motor at a relatively slow and continuous (or substantially continuous) speed, such as one revolution per day (or longer) in some embodiments. Alternately or additionally, the speed of the electric motor or other component of the dynamic adjustment assembly may be modulated to operate faster or slower based on one or more specific trigger events. Examples of trigger events may include a performance parameter satisfying a performance threshold, physiological data satisfying a particular criterion, or other suitable trigger event. The transition via the relatively slow and continuous change from the first state to the second state may substantially avoid the pain, reduced typing speed, reduced typing accuracy, and/or other potential negative effects of switching directly from a non-ergonomic keyboard to an ergonomic keyboard. For example, the shape-changing keyboard may take a week or more to continuously transition from the first or initial non-ergonomic state to the second or ergonomic state.

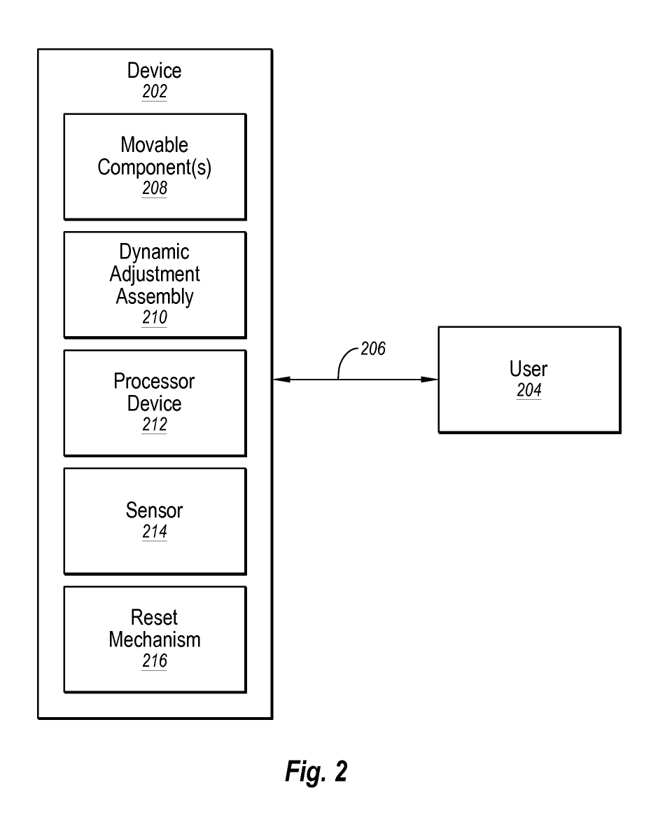

FIG. 2 is a block diagram of an example device 202 configured to adjust between a first state and a second state, in accordance with at least some embodiments described herein. Generally, the second state may include a more ergonomic state than the first state. In the discussion that follows, the first state may be described as an initial non-ergonomic state and the second state may be described as an ergonomic state. More generally, the second state may include any state that is relatively more ergonomic than the first state.

The device 202 may dynamically transition from the initial non-ergonomic state to the ergonomic state. The transition may occur through multiple incremental states corresponding to multiple incremental changes of position and/or orientation of all or a portion of the device 202. For each incremental state, e.g., after each incremental change, a user 204 of the device 202 may be allotted a time period to adapt to the incremental state, referred to herein as an “adaptation period,” before the device 202 transitions to a subsequent incremental state by making a subsequent incremental change. The device 202 may include, for example, a shape-changing keyboard, power tools such as drills, assistive devices such as canes and walkers, bicycle handlebars, a computer monitor, or other device with a relatively large difference between a standard non-ergonomic configuration and an ergonomic configuration. The user 204 may include any person or other user of the device 202 who may use the device 202, as indicated by an arrow 206.

The device 202 may include one or more movable components 208 and a dynamic adjustment assembly 210. In embodiments in which the device 202 includes a shape-changing keyboard, the one or more movable components 208 may include a first segment and a second segment. For convenience in the discussion that follows, the one or more movable components 208 may be referred to in singular form, e.g., movable component 208. The movable component 208 may have various characteristics such as a position and an orientation. In some embodiments, the user 204 may physically interact with the movable component 208 during use of the device 202. For instance, the user 204 may rest hands or fingers on the movable component 208 and/or may depress keys included in or on the movable component 208 in the example of a shape-changing keyboard.

The dynamic adjustment assembly 210 may be operably coupled to at least a portion of the movable component 208. The dynamic adjustment assembly 210 may be configured to automatically change the device 202 from an initial non-ergonomic state to an ergonomic state by automatic change over time of a position and/or orientation of the movable component 208. In at least one embodiment in which the movable component 208 includes first and second segments of a shape-changing keyboard, the dynamic adjustment assembly 210 may be coupled between the first and second segments and the dynamic adjustment assembly 210 may be configured to automatically change the shape-changing keyboard from an initial non-ergonomic state to an ergonomic state by automatic change over time of a position and/or orientation of one or both of the first and second segments. Although the changes may be described here and elsewhere as being made automatically, in other embodiments, the changes may not be made automatically. For instance, the changes may be made responsive to user commands or manually.

The dynamic adjustment assembly 210 may include an electric motor, which may be electrically coupled to an electrical power source that provides electrical power to operate the dynamic adjustment assembly 210. For instance, the electrical power source may include mains electricity, a low voltage power source within or external to the device 202, a battery within or external to the device 202, and/or other suitable electrical power source types such as regulated power sources (linear, non-linear, switched mode or contiguous), unregulated power sources (AC adapter, AC/DC adapter, AC/DC converter), or other suitable power source or power supply.

Alternately or additionally, the dynamic adjustment assembly 210 may be configured to derive operating power from forces applied on or to the device 202 during use of the device 202. The forces applied on or to the device during use of the device 202 may be converted by the dynamic adjustment assembly 210 or other component of the device 202 to a motion used to change a position and/or orientation of at least a portion of the device 202. In these and other embodiments, the dynamic adjustment assembly 210 and/or the device 202 may include a motor with one or more components that cooperate to change a position and/or orientation of at least a portion of the device 202 in response to application of forces to the device 202 (or at least a portion thereof) during use of the device 202. Example embodiments and aspects of such a motor are disclosed in PCT International Application Number PCT/US2013/064218, filed Oct. 31, 2013, which application is herein incorporated by reference in its entirety.

The device 202 may optionally further include one or more of a processor device 212, a sensor 214, and a reset mechanism 216. Alternately, the processor device 212, the sensor 214, and/or the reset mechanism 216 may be omitted from the device 202. In some embodiments, one or more of the processor device 212, the sensor 214, and the reset mechanism 216 may be omitted from the device 202 and may be included in a computer to which the device 202 may be communicatively coupled.

In some embodiments, the processor device 212 may be communicatively coupled to the dynamic adjustment assembly 210. In these and other embodiments, the processor device 212 may be configured to generate control signals that are provided to and control operation of the dynamic adjustment assembly 210 to thereby control automatic changes to the movable component 208.

Alternately or additionally, the processor device 212 may be configured to identify trigger events when the device 202 is in a preceding state that may include the initial non-ergonomic or an intermediate state and, in response to the trigger events, cause the dynamic adjustment assembly to change the device 202 from the preceding state to a subsequent state that may include an intermediate state or the ergonomic state.

One or more sensors, such as sensor 214, may be communicatively coupled to the processor device 212. In some examples, sensor 214 is configured to generate one or more signals that are electrically transmitted for receipt by the processor device 212. The processor device 212 may be configured to identify trigger events from a signal or signals generated by the sensor 214. In embodiments in which the device 202 includes a shape-changing keyboard, the sensor 214 may include a timer, a typing speed sensor, a typing accuracy sensor, an electromyography (EMG) sensor, or other suitable sensor. The sensor 214 may be implemented in hardware and/or software. For instance, the sensor 214 may include a software module that analyzes data generated by the device 202 or a use pattern of the device 202, such as length of usage duration of the device 202. Although a single sensor 214 is illustrated in FIG. 2, the device 202 may alternately or additionally include multiple sensors. The signal or signals generated by the sensor 214 and provided to the processor device 212 may include a signal indicating, for instance, passage of a particular period of time since a previous trigger event was detected, a clock signal, a signal indicating a typing speed of the user 204, a signal indicating a typing accuracy of the user 204, an EMG signal from electrodes attached to the user's wrist or wrists, or other suitable signal. Alternately or additionally, the signal or signals may include an EMG signal or signals from electrodes deposited on keys of the device 202 (in the case of the device 202 including a shape-changing keyboard) and the electrodes may pick up EMG signals when fingers of the user 204 rest on the keys between typing. The trigger events identified by the processor device 212 may include passage of a particular period of time since a previous trigger event was detected, the typing speed of the user 204 satisfying a typing speed threshold, the typing accuracy of the user 204 satisfying a typing accuracy threshold, the EMG signal having one or more particular characteristics, or other suitable trigger event. The particular period of time, the typing speed threshold, the typing accuracy threshold, and/or other criteria used by the processor device 212 to identify trigger events may include default values and/or values selected or input by the user 204.

Accordingly, the automatic change of the device 202 may be controlled by a feedback loop executed by the processor device 212. In these and other embodiments, the processor device 212 may be configured to repeatedly measure a performance parameter. The processor device 212 may be further configured to, in response to the performance parameter being at or above a performance threshold, repeatedly operate the dynamic adjustment assembly to effect an incremental change of a position and/or orientation of one or both of the first and second segments.

The reset mechanism 216 may be operably coupled to one or both of the movable component 208 and the dynamic adjustment assembly 210. Alternately or additionally, the reset mechanism 216 may be communicatively coupled to the processor device 212. In these and other embodiments, the device 202 may be configured to be returned to the initial non-ergonomic state in response to actuation of the reset mechanism 216. The reset mechanism 216 may be configured to facilitate a user-initiated reset of the device 202 to the non-ergonomic state at any time. For instance, a reset may be initiated by the user 204 when the user 204 objects to a current intermediate state of the device 202 or if a new user is using the device 202. The reset mechanism 216 may include one or more switches, one or more relays, one or more solid state switches, or other suitable components that may be configured to, for example, at least temporarily release the dynamic adjustment assembly 210 from the movable component 208. Alternately or additionally, the reset mechanism 216 may be implemented as a software command sent to the device 202 by an external system, and/or sent from the processor device 212 to the dynamic adjustment assembly 210 or other component of the device 202.

Alternately or additionally, the device 202 may include or may be coupled to memory or other computer storage. Information associated with use of the device 202 by one or more users 204 may be saved in the computer storage. For example, the computer storage may store a first state, a second state, and a current state of the device 202 for each of the one or more users 204. The first, second, and/or current state for one of the one or more users 204 may be different than the first, second, and/or current state for a different one of the one or more users 204. Each of the one or more users 204 may login to use the device 202, in response to which the device 202 may transition to (or remain at) a current state associated with the corresponding one of the one or more users 204. The device 202 may then continue its transition from the first state to the second state for the corresponding one of the one or more users 204 and/or may save an updated current state when the corresponding one of the users 204 stops using the device 202 or logs out.

The performance of the user 204 with the device 202 may be measured and used in a feedback loop. For example, in embodiments in which the device 202 is a shape-changing keyboard, the typing speed, typing accuracy, or other performance parameter of the device 202 over time when in use by the user 204 may be measured, e.g., by the sensor 214. In response to the performance parameter satisfying a corresponding performance threshold, the processor device 212 may identify a trigger event as described herein and may initiate the dynamic adjustment assembly 210 to effect an incremental change in position and/or orientation of the movable component 208.

FIGS. 3A-3E include various views of an example embodiment of a shape-changing keyboard 300 (hereinafter “keyboard 300”), arranged in accordance with at least some embodiments described herein. The keyboard 300 may be an example of a specific embodiment of the device 202 of FIG. 2.

The keyboard 300 may include a first segment 302A and a second segment 302B (collectively “segments 302”). The first segment 302A may include a first key assembly 304A that includes a multiple number of keys (not labeled). Analogously, the second segment 302B may include a second key assembly 304B that includes a multiple number of keys (not labeled). The first and second key assemblies 304A and 304B may be collectively referred to as “key assemblies 304.”

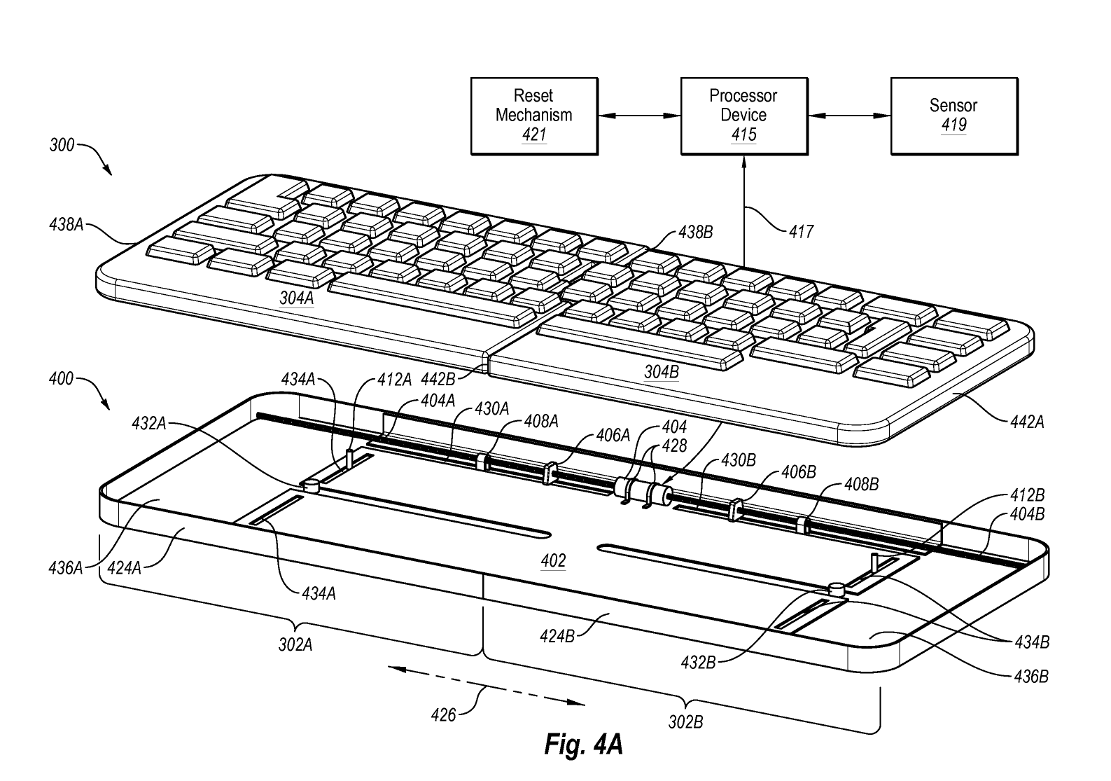

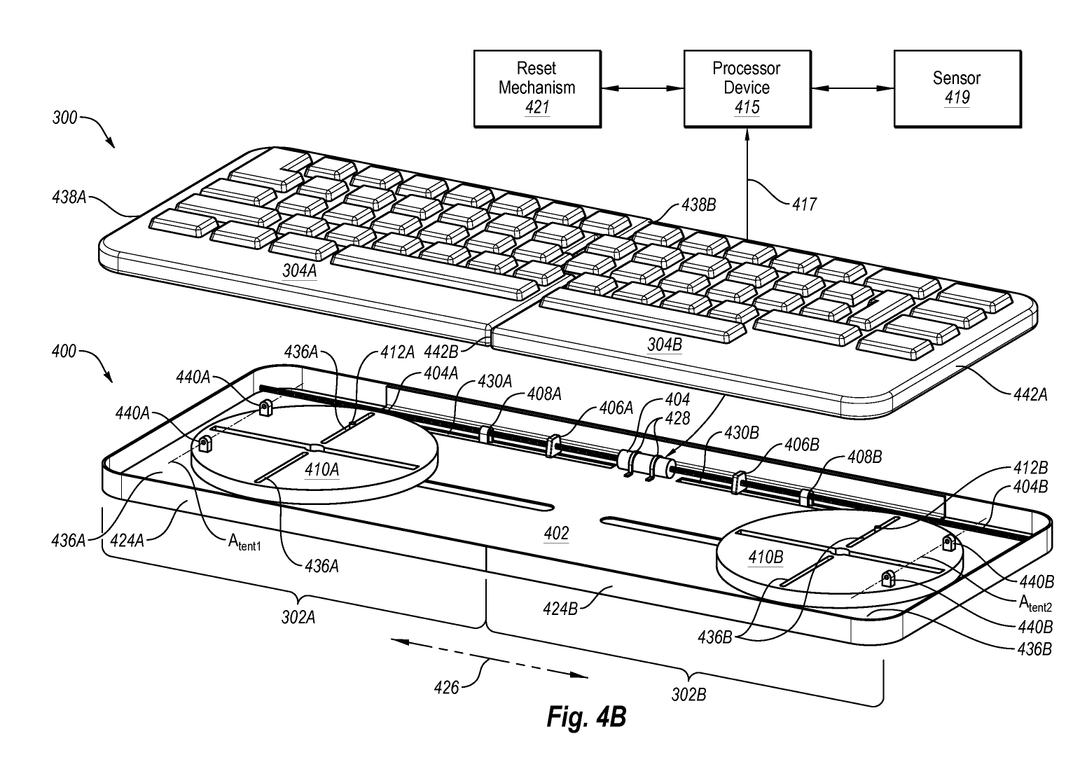

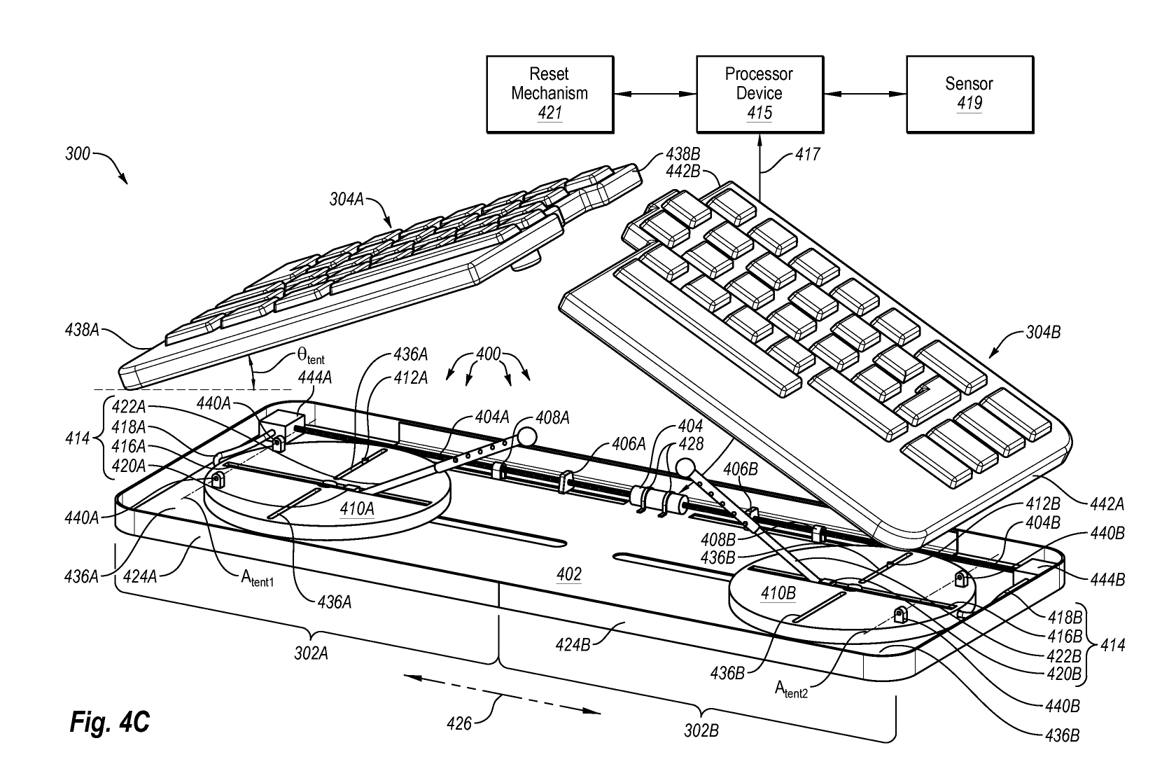

The segments 302 and/or the key assemblies 304 may correspond to the movable component 208 of FIG. 2. For instance, one or more of the first segment 302A, the second segment 302B, the first key assembly 304A, and/or the second key assembly 304B may be movable by a dynamic adjustment assembly (e.g., dynamic adjustment assembly 400 in FIGS. 4A-4C) of the keyboard 300 to change a position and/or orientation of the first segment 302A, the second segment 302B, the first key assembly 304A, and/or the second key assembly 304B.

FIG. 3A is an overhead view of the keyboard 300 in an initial non-ergonomic state that may generally correspond to the configuration of a standard non-ergonomic keyboard.

FIGS. 3B and 3C include overhead views, FIG. 3D includes a front view, and FIG. 3E includes a side view of the keyboard 300. FIGS. 3B-3E further illustrate various adjustable parameters of the keyboard 300 that may be adjusted to change the position and/or orientation of the first segment 302A, the second segment 302B, the first key assembly 304A, and/or the second key assembly 304B. As explained herein, the adjustment of one or more of the parameters may be controlled by a processor device, such as the processor device 212 of FIG. 2. For example, the processor device may be communicatively coupled to an electric motor, a solenoid, or other actuator, and control signals from the processor device may cause the actuator to change the position and/or orientation of at least a portion of the keyboard 300. While multiple adjustable parameters are illustrated in FIGS. 3B-3E, more generally, the keyboard 300 may include a single one of the adjustable parameters of FIGS. 3B-3E, all of the adjustable parameters of FIGS. 3B-3E, any combination of the adjustable parameters of FIGS. 3B-3E, and/or at least one other adjustable parameter instead of or in addition to the adjustable parameters of FIGS. 3B-3E. The illustrated adjustable parameters may include a separation distance d (FIG. 3B), a splay angle θ_{splay} (FIG. 3C), a tent angle θₜₑₙₜ (FIG. 3D), and a tilt angle θ_{bit} (FIG. 3E).

FIG. 3B illustrates the separation distance d. The separation distance d may refer to the distance that separates the first segment 302A from the second segment 302B. The separation distance d may be adjusted by changing a position of one or both of the first segment 302A and the second segment 302B relative to the other. Various components that may facilitate and/or control adjustments to the separation distance d and/or other parameters according to some embodiments are illustrated in and described with respect to FIGS. 4A-4C. In some embodiments, the separation distance d in the initial non-ergonomic state of FIG. 3A may be equal to a first separation distance threshold value such as about zero. In an ergonomic state (not illustrated) of the keyboard 300, the separation distance d may be equal to a second separation distance threshold value determined by one or more stopper members, as described with respect to FIGS. 4A-4C.

FIG. 3C illustrates the splay angle θ_{splay}. The first key assembly 304A and the second key assembly 304B may have the same splay angles θ_{splay} as illustrated in FIG. 3C, or different splay angles θ_{splay}. The splay angle θ_{splay} may refer to the rotation angle of the first key assembly 304A or the second key assembly 304B with respect to a reference bisection plane 306 that is orthogonal to horizontal. In some embodiments, the splay angle θ_{splay} in the initial non-ergonomic state of FIG. 3A may be equal to a first splay angle threshold value such as about zero. In the ergonomic state of the keyboard 300, the splay angle θ_{splay} may be equal to a second splay angle threshold value determined by one or more disk stopper members, as described with respect to FIGS. 4A-4C.

FIG. 3D illustrates the tent angle θₜₑₙₜ. The first key assembly 304A and the second key assembly 304B may have the same tent angles θₜₑₙₜ as illustrated in FIG. 3D, or different tent angles θₜₑₙₜ. The tent angle θₜₑₙₜ may refer to the rotation angle of the first key assembly 304A or the second key assembly 304B about a tent axis Aₜₑₙₜ₁ or Aₜₑₙₜ₂. In some embodiments, the tent axes Aₜₑₙₜ₁ and Aₜₑₙₜ₂ are substantially parallel and define a reference plane 308 that may be substantially parallel to horizontal. Alternately, the reference plane 308 may intersect horizontal at an angle equal to the tilt angle _{tilt.} In some embodiments, the tent angle θₜₑₙₜ in the initial non-ergonomic state of FIG. 3A may be equal to a first tent angle threshold value such as about zero. In the ergonomic state of the keyboard 300, the tent angle θₜₑₙₜ may be equal to a second tent angle threshold value, as described with respect to FIGS. 4A-4C.

FIG. 3E illustrates the tilt angle θₜᵢₗₜ. The first key assembly 304A and the second key assembly 304B may have the same tilt angles θₜᵢₗₜ as illustrated in FIG. 3E, or different tilt angles θₜᵢₗₜ. The tilt angle _{Kit} may refer to the rotation angle of the first key assembly 304A or the second key assembly 304B about a tilt axis Aₜᵢₗₜ₁ or Aₜᵢₗₜ₂. In some embodiments, the tilt axes Aₜᵢₗₜ₁ and Aₜᵢₗₜ₂ may be approximately collinear (as illustrated in FIG. 3E), such as when θ_{splay} and θₜₑₙₜ for both key assemblies 304 are substantially equal to zero. In other embodiments, such as when θ_{splay} and/or θₜₑₙₜ for one or both key assemblies 304 is nonzero, the tilt axes Aₜᵢₗₜ₁ and Aₜᵢₗₜ₂ may not be collinear. Alternately or additionally, the tilt axes Aₜᵢₗₜ₁ and Aₜᵢₗₜ₂ may be substantially parallel to and/or include a horizontal reference plane 310. The horizontal reference plane 310 may be substantially parallel to horizontal. In some embodiments, the tilt angle θₜᵢₗₜ in the initial non-ergonomic state of FIG. 3A may be equal to a first tilt angle threshold value. In the ergonomic state of the keyboard 300, the tilt angle θₜᵢₗₜ may be equal to a second tilt angle threshold value.

FIGS. 4A-4C include various partially exploded perspective views of an example embodiment of the keyboard 300 of FIGS. 3A-3E, arranged in accordance with at least some embodiments described herein. The components illustrated in FIGS. 4A-4C vary from figure to figure to allow different portions of the keyboard 300 to be viewed in different figures. The keyboard 300 illustrated in FIGS. 4A-4C includes the first segment 302A, the second segment 302B, the first key assembly 304A, and the second key assembly 304B of FIGS. 3A-3E.

The keyboard 300 may additionally include a dynamic adjustment assembly 400. The dynamic adjustment assembly 400 may include one or more of a base plate 402, an electric motor 404, a first movable member 406A, a second movable member 406B, a first stopper member 408A, a second stopper member 408B, a first disk 410A (FIGS. 4B and 4C), a second disk 410B (FIGS. 4B and 4C), a first disk stopper member 412A (FIGS. 4B and 4C), a second disk stopper member 412B (FIGS. 4B and 4C), and a lift assembly 414 (FIG. 4C). The lift assembly 414 may include one or more of a first threaded shaft 416A (FIG. 4C), a second threaded shaft 416B (FIG. 4C), a first flexible linkage 418A (FIG. 4C), a second flexible linkage 418B (FIG. 4C), a third movable member 420A (FIG. 4C), a fourth movable member 420B (FIG. 4C), a first rigid elongate member 422A (FIG. 4C), and a second rigid elongate member 422B (FIG. 4C).

Various other components may be included in the keyboard 300 as described in more detail below. Additionally, the first segment 302A may include a lower housing 424A and the second segment 302B may include a lower housing 424B.

Alternately or additionally, the keyboard 300 may include or be communicatively coupled to a processor device 415. In these and other embodiments, the processor device 415 may be communicatively coupled to the electric motor 404, other component(s) of the dynamic adjustment assembly 400, and/or other components of the keyboard 300. In the illustrated embodiment, the processor device 415 may be communicatively coupled to the electric motor 404 via an electrical interface 417 that may include one or more signal and/or control lines. The processor device 415 may control the electric motor 404, and more generally the dynamic adjustment assembly 400, by communicating control signals to the electric motor 404 via the electrical interface 417. The control signals may cause the electric motor 404 or other component(s) of the dynamic adjustment assembly 400 to operate in a manner that effects a change in a position and/or orientation of one or both of the first and second key assemblies 304A and 304B.

The processor device 415 may be communicatively coupled to one or more sensors 419 and/or to a reset mechanism 421. Alternately or additionally, reset mechanism 421 may be mechanically and/or communicatively coupled to the electric motor 404 or other component(s) of the dynamic adjustment assembly 400. The processor device 415, the sensor 419, and the reset mechanism 421 are, respectively, examples of the processor device 212, the sensor 214, and the reset mechanism 216 of FIG. 2. Accordingly, the description herein of the processor device 212, the sensor 214, and the reset mechanism 216 of FIG. 2 may also apply, respectively, to the processor device 415, the sensor 419, and the reset mechanism 421 of FIGS. 4A-4C.

With reference to FIG. 4A, the base plate 402 may be slidably coupled to both a portion of the first lower housing 424A and a portion of the second lower housing 424B. The slidable coupling between the base plate 402 and the first and second lower housings 424A and 424B may be configured to facilitate lateral translation of the first segment 302A and/or the second segment 302B in the direction denoted at 426 with respect to the base plate 402 and/or with respect to each other so as to adjust the separation distance d (FIG. 3B) between the segments 302.

The electric motor 404 may be coupled to a portion of the base plate 402. For instance, the keyboard 300 may include u-bolts 428 that couple the electric motor 404 to the portion of the base plate 402. The electric motor 404 may include a first threaded drive shaft 404A that extends from a first side of the electric motor 404 and a second threaded drive shaft 404B that extends from a second side of the electric motor 404 that is opposite the first side of the electric motor 404. The second threaded drive shaft 404B may be coaxial with the first threaded drive shaft 404A in some embodiments. Alternately, the first and second threaded drive shafts 404A and 404B may not be coaxial. Although a single electric motor 404 is illustrated in FIGS. 4A-4C, in other embodiments, the keyboard 300 may include two or more electric motors 404. Alternately or additionally, the electric motor 404 may be indirectly coupled to one or both of the first and second threaded drive shafts 404A and 404B through one or more gears or other intermediate components.

The first movable member 406A may be threadably coupled to the first threaded drive shaft 404A. In some embodiments, the first movable member 406A includes a nut with internal threads that are complementary to threads of the first threaded drive shaft 404A. The first movable member 406A may be configured to be translated along the first threaded drive shaft 404A in response to rotation of the first threaded drive shaft 404A by the electric motor 404. For instance, the first movable member 406A may have a shape that partially engages with the base plate 402 to substantially prevent the first movable member 406A from rotating when the first threaded drive shaft 404A is rotated by the electric motor 404. The first movable member 406A may nevertheless translate in the direction 426 in response to rotation of the first threaded drive shaft 404A by the electric motor 404.

The first stopper member 408A may be coupled to a portion of the first lower housing 424A in a translation path of the first movable member 406A. The first stopper member 408A may be configured to stop the first movable member 406A from translating past the first stopper member 408A along the first threaded drive shaft 404A. The first stopper member 408A may include a clip or a fastener or other component made of metal, plastic, or other suitable material that can be coupled to the portion of the first lower housing 424A. The portion of the first lower housing 424A to which the first stopper member 408A is coupled may define a first adjustment slot 430A within which the first stopper member 408A may be manually or electronically movable with respect to the first lower housing 424A.

In operation, the first movable member 406A may be translated along the first threaded drive shaft 404A in response to rotation of the first threaded drive shaft 404A by the electric motor 404 until the first movable member 406A reaches the first stopper member 408A. In response to operation of the electric motor 404 continuing to rotate the first threaded drive shaft 404A in the same direction that caused the first movable member 406A to translate toward and reach the first stopper member 408A, the first movable member 406A may engage the first lower housing 424A through the first stopper member 408A. The first movable member 406A may thereafter cause the first lower housing 424A to translate in the direction 426, for example to the left, as the first movable member 406A translates along the first threaded drive shaft 404A.

Analogously, the second movable member 406B may be threadably coupled to the second threaded drive shaft 404B. In some embodiments, the second movable member 406B includes a nut with internal threads that are complementary to threads of the second threaded drive shaft 404B. The second movable member 406B may be configured to be translated along the second threaded drive shaft 404B in response to rotation of the second threaded drive shaft 404B by the electric motor 404. For instance, the second movable member 406B may have a shape that partially engages with the base plate 402 to substantially prevent the second movable member 406B from rotating when the second threaded drive shaft 404B is rotated by the electric motor 404. The second movable member 406B may nevertheless translate in the direction 426 in response to rotation of the second threaded drive shaft 404B by the electric motor 404.

The second stopper member 408B may be coupled to a portion of the second lower housing 424B in a translation path of the second movable member 406B. The second stopper member 408B may be configured to stop the second movable member 406B from translating past the second stopper member 408B along the second threaded drive shaft 404B. The second stopper member 408B may include a clip or a fastener or other component made of metal, plastic, or other suitable material that can be coupled to the portion of the second lower housing 424B. The portion of the second lower housing 424B to which the second stopper member 408B is coupled may define a second adjustment slot 430B within which the second stopper member 408B may be manually or electronically movable with respect to the second lower housing 424B.

In operation, the second movable member 406B may translate along the second threaded drive shaft 404B in response to rotation of the second threaded drive shaft 404B by the electric motor 404 until the second movable member 406B reaches the second stopper member 408B. In response to the electric motor 404 continuing to rotate the second threaded drive shaft 404B in the same direction that caused the second movable member 406B to translate toward and reach the second stopper member 408B, the second movable member 406B may engage the second lower housing 424B through the second stopper member 408B. The second movable member 406B may thereafter cause the second lower housing 424B to translate in the direction 426, and more specifically to the right, as the second movable member 406B translates along the second threaded drive shaft 404B.

In some embodiments, the position of the first stopper member 408A with respect to the first lower housing 424A within the first adjustment slot 430A may be adjusted to determine a second separation distance threshold value between the first segment 302A and the second segment 302B. Alternately or additionally, the position of the second stopper member 408B with respect to the second lower housing 424B within the second adjustment slot 430B may be adjusted to determine the second separation distance threshold value between the first segment 302A and the second segment 302B. For instance, the second separation distance threshold value may be relatively greater the closer the first and second stopper members 408A and 408B are positioned within the first and second adjustment slots 430A and 430B relative to the electric motor 404.

The electric motor 404, the first and second threaded drive shafts 404A and 404B, and/or the first and second movable members 406A and 406B may be configured such that, during operation of the electric motor 404, both of the first and second threaded drive shafts 404A and 404B may be rotated simultaneously. In these and other embodiments, the first and second movable members 406A and 406B may be simultaneously translated away from or toward the electric motor 404, or one may be translated away from the electric motor 404 while the other is translated toward the electric motor 404. In other embodiments, the electric motor 404 or two or more electric motors 404 may rotate the first and second threaded drive shafts 404A and 404B independently of each other.

Alternately or additionally, the electric motor 404 or two or more electric motors 404 or one or more solenoids may linearly drive one or more rigid or semi-rigid rods or shafts in the direction 426. At least one of the rods may have an end coupled to one of the first or second key assemblies 304A or 304B and/or to one of the lower housings 424A or 424B. The electric motor(s) 404 or solenoid may be coupled to the base plate 402 or to the other of the first or second key assemblies 304A or 304B or to the other of the lower housings 424A or 424B. The electric motor(s) 404 or solenoid may then extend or retract the rod to increase or decrease the separation distance. Other configurations for controlling the separation distance between the first and second key assemblies 304A and 304B may alternately or additionally be implemented.

Alternately or additionally, a bias member such as a spring may be coupled between the first and second lower housings 424A and 424B. The bias member may be configured to bias the first and second lower housings 424A and 424B together. In some embodiments, for instance, the bias member may be configured to pull the first and second lower housings 424A and 424B together in response to the first and second movable members 406A and 406B being translated back toward the electric motor 404 and disengaging from the first and second stopper members 408A and 408B.

FIG. 4A additionally illustrates first and second disk axis pins 432A and 432B and first and second disk stopper adjustment slots 434A and 434B. The first and second disk axis pins 432A and 432B may define disk axes for the first and second disks 410A and 410B as described in more detail with respect to FIG. 4B. The first and second disk stopper adjustment slots 434A and 434B may be configured to receive the first and second disk stopper members as described in more detail below.

Referring to FIG. 4B, the first disk 410A may be rotatably coupled to a portion of the first lower housing 424A. For instance, the first disk 410A may be rotatably coupled to the first disk axis pin 432A (FIG. 4A) and may be rotatable about the disk axis defined by the first disk axis pin 432A. The disk axis defined by the first disk axis pin 432A may be substantially normal to a lower surface 436A of the first lower housing 424A. The first disk 410A may include one or more radial slots 436A that extend radially outward at least partially between a center and a perimeter of the first disk 410A. Although the first disk 410A is illustrated as a disk, the first disk 410A may alternately or additionally include a gear, a component that includes an elliptical shape or other shape, or other suitable component.

The first disk stopper member 412A may be coupled to a portion of the base plate 402. The first disk stopper member 412A may be configured to stop the first disk 410A from rotating beyond a pre-selected angle. The first disk stopper member 412A may include a clip or a fastener or other component made of metal, plastic, or other suitable material that can be coupled to the portion of the base plate 402. The portion of the base plate 402 to which the first disk stopper member 412A may be coupled may define the first disk stopper adjustment slot 434A. The first disk stopper member 412A may be manually or electronically movable within the first disk stopper adjustment slot 434A. The first disk stopper member 412A may extend upward from the base plate 402 at least partially through the radial slot 436A.

The first key assembly 304A may be coupled to a portion of the first disk 410A. In these and other embodiments, the first key assembly 304A may include a first end portion 438A and a second end portion 438B opposite the first end portion 438A. The first key assembly 304A may be rotatably coupled along a portion of the first end portion 438A to the first disk 410A. The portion of the first disk 410A to which the first key assembly 304A is coupled may include tabs 440A that define the tent axis Aₜₑₙₜ₁ .

In operation, translational movement of the first lower housing 424A in the direction 426 may cause rotation of the first disk 410A and of the first key assembly 304A coupled thereto. In more detail, because the first disk 410A is rotatably coupled to the first lower housing 424A, movement of the first lower housing 424A in the direction 426 may cause translational movement of the first disk axis pin 432A and thus of the first disk 410A and the first key assembly 304A in the direction 426. Moreover, the first disk stopper member 412A that extends at least partially through the radial slot 436A is coupled to the base plate 402 and thus remains stationary during translational movement of the first lower housing 424A and the first disk 410A relative to the base plate 402. Accordingly, the first disk stopper member 412A may cause the first disk 410A and the first key assembly 304A coupled thereto to rotate in response to translational movement of the first lower housing 424A and the first disk 410A in the direction 426. For instance, in response to the first lower housing 424A and the first disk 410A translating to the left relative to the base plate 402, the first disk 410A and the first key assembly 304A may rotate clockwise. Analogously, in response to the first lower housing 424A and the first disk 410A translating to the right relative to the base plate 402, the first disk 410A and the first key assembly 304A may rotate counterclockwise. The angle of rotation of the first disk 410A and of the first key assembly 304A about the disk axis defined by the first disk axis pin 432A may correspond to the splay angle θ_{splay} (FIG. 3C) of the first key assembly 304A.

In some embodiments, the position of the first disk stopper member 412A with respect to the base plate 402 within the first disk stopper adjustment slot 434A may determine a second splay angle threshold value for the first disk 410A and the first key assembly 304A. For instance, the closer the first disk stopper member 412A is positioned within the first disk stopper adjustment slot 434A to the first disk axis pin 432A, the greater the second splay angle threshold value may be for the first disk 410A and the first key assembly 304A.

The second key assembly 304B may be configured to rotate about the disk axis defined by the second disk axis pin 432B in an analogous manner using analogous components as the first key assembly 304A. In more detail, the second disk 410B may be rotatably coupled to a portion of the second lower housing 424B. For instance, the second disk 410B may be rotatably coupled to the second disk axis pin 432B (FIG. 4A) and may be rotatable about the disk axis defined by the second disk axis pin 432B. The disk axis defined by the second disk axis pin 432B may be substantially normal to a lower surface 436B of the second lower housing 424B. The second disk 410B may include one or more radial slots 436B that extend radially outward at least partially between a center and a perimeter of the second disk 410B. Although the second disk 410B is illustrated as a disk, the second disk 410B may alternately or additionally include a gear, a component that includes an elliptical shape or other shape, or other suitable component.

The second disk stopper member 412B may be coupled to a portion of the base plate 402. The second disk stopper member 412B may be configured to stop the second disk 410B from rotating beyond a pre-selected angle. The second disk stopper member 412B may include a clip or a fastener or other component made of metal, plastic, or other suitable material that can be coupled to the portion of the base plate 402. The portion of the base plate 402 to which the second disk stopper member 412B may be coupled may define the second disk stopper adjustment slot 434B. The second disk stopper member 412B may be manually or electronically movable within the second disk stopper adjustment slot 434B. The second disk stopper member 412B may extend upward from the base plate 402 at least partially through the radial slot 436B.

The second key assembly 304B may be coupled to a portion of the second disk 410B. In these and other embodiments, the second key assembly 304B may include a first end portion 442A and a second end portion 442B opposite the first end portion 442A. The second key assembly 304B may be rotatably coupled along a portion of the first end portion 442A to the second disk 410B. The portion of the second disk 410B to which the second key assembly 304B is coupled may include tabs 440B that define the tent axis Aₜₑₙₜ₂.

In operation, translational movement of the second lower housing 424B in the direction 426 may cause rotation of the second disk 410B and of the second key assembly 304B coupled thereto. In more detail, because the second disk 410B is rotatably coupled to the second lower housing 424B, movement of the second lower housing 424B in the direction 426 may cause translational movement of the second disk axis pin 432B and thus of the second disk 410B and the second key assembly 304B in the direction 426. Moreover, the second disk stopper member 412B that extends at least partially through the radial slot 436B is coupled to the base plate 402 and thus remains stationary during translational movement of the second lower housing 424B and the second disk 410B relative to the base plate 402. Accordingly, the second disk stopper member 412B may cause the second disk 410B and the second key assembly 304B coupled thereto to rotate in response to translational movement of the second lower housing 424B and the second disk 410B in the direction 426. For instance, in response to the second lower housing 424B and the second disk 410B translating to the right relative to the base plate 402, the second disk 410B and the second key assembly 304B may rotate counterclockwise. Analogously, in response to the second lower housing 424B and the second disk 410B translating to the left relative to the base plate 402, the second disk 410B and the second key assembly 304B may rotate clockwise. The angle of rotation of the second disk 410B and of the second key assembly 304B about the disk axis defined by the second disk axis pin 432B may correspond to the splay angle θ_{splay} (FIG. 3C) of the second key assembly 304B.

In some embodiments, the position of the second disk stopper member 412B with respect to the base plate 402 within the second disk stopper adjustment slot 434B may determine a second splay angle threshold value for the second disk 410B and the second key assembly 304B. For instance, the closer the second disk stopper member 412B is positioned within the second disk stopper adjustment slot 434B to the second disk axis pin 432B, the greater the second splay angle threshold value may be for the second disk 410B and the second key assembly 304B.

Referring to FIG. 4C, the lift assembly 414 may be coupled to a portion of the first threaded drive shaft 404A, the first disk 410A, and the second end portion 438B of the first key assembly 304A. The lift assembly 414 may be configured to adjust the tent angle θₜₑₙₜ of the first key assembly 304A relative to the first disk 410A about the tent axis Aₜₑₙₜ₁. The tent axis Aₜₑₙₜ₁ may be substantially parallel to the first end portion 438A of the first key assembly 304A.

In more detail, the first threaded shaft 416A of the lift assembly 414 may be coupled to a portion of a top surface of the first disk 410A.

The first flexible linkage 418A of the lift assembly 414 may be coupled between the first threaded drive shaft 404A and the first threaded shaft 416A. In some embodiments, a first gearbox 444A may couple an end of the first flexible linkage 418A to an end of the first threaded drive shaft 404A. The gearbox 444A may include a 90-degree gearbox or a gearbox of another angle. The first flexible linkage 418A may rotate in response to rotation of the first threaded drive shaft 404A by the electric motor 404. Moreover, rotation of the first flexible linkage 418A may cause the first threaded shaft 416A to rotate. The first flexible linkage 418A may be flexible to allow the transfer of torque from the first threaded drive shaft 404A to the first threaded shaft 416A while accommodating translational movement and/or rotational movement of the first disk 410A relative to the base plate 402.

The third movable member 420A of the lift assembly 414 may be coupled to a portion of the first threaded shaft 416A. The third movable member 420A may be configured to translate along the first threaded shaft 416A to a lockable position to raise or lower the second end portion 438B of the first key assembly 304A. For example, the third movable member 420A may include a nut, analogous to the first movable member 406A, that is configured to translate along the first threaded shaft 416A in response to rotation of the first threaded drive shaft 404A, the first flexible linkage 418A, and the first threaded shaft 416A by the electric motor 404. In these and other embodiments, the first threaded shaft 416A may be coupled to the first disk 410A at opposing ends of the first threaded shaft 416A to allow the third movable member 420A to translate substantially along a length of the first threaded shaft 416A.

The first rigid elongate member 422A of the lift assembly 414 may include a first end slidably coupled to a portion of the first threaded shaft 416A and a second end rotatably coupled to a portion of the second end portion 438B of the first key assembly 304A. The second end of the first rigid elongate member 422A may be rotatably coupled to the portion of the second end portion 438B by a ball joint, for example. The first end of the first rigid elongate member 422A slidably coupled to the portion of the first threaded shaft 416A may be configured to translate along the first threaded shaft 416A in response to translation of the third movable member 420A along the first threaded shaft 416A.

For instance, when the third movable member 420A is adjacent to the first end of the first rigid elongate member 422A, translation of the third movable member 420A along the first threaded shaft 416A to the right may force the first end of the first rigid elongate member 422A to also translate to the right. Moreover, the first rigid elongate member 422A may be substantially rigid, the second end of the first rigid elongate member 422A may be rotatably coupled to the second end portion 438B of the first key assembly 304A, and the first end portion 438A of the first key assembly 304 may be rotatably coupled to the first disk 410A. As such, translation of the first end of the first rigid elongate member 422A to the right along the first threaded shaft 416A may cause the second end portion 438B of the first key assembly 304A to be elevated by the tent angle θₜₑₙₜ.

Translation of the third movable member 420A along the first threaded shaft 416A to the left may urge translation of the first end of the first rigid elongate member 422A to the left. In some embodiments, a weight of the first key assembly 304A against the second end of the first rigid elongate member 422A may be sufficient to force the second end of the first rigid elongate member 422A downward and the first end of the first rigid elongate member 422A leftward as the third movable member 420A translates to the left.

A length of the first rigid elongate member 422A may determine a second tent angle threshold value for the first key assembly 304A. For instance, the greater the length of the first rigid elongate member 422A, the greater the second tent angle threshold value may be for the first key assembly 304A. In these and other embodiments, the first rigid elongate member 422A may include two axially aligned sleeves slidably coupled together or some other suitable configuration. A slidable position of the two axially aligned sleeves may be manually and/or electronically adjustable and/or may be lockable by a stopper member at least partially inserted through one or both of the sleeves to determine the length of the first rigid elongate member 422A.

The foregoing describes the interconnections between and operation of the lift assembly 414 and the first key assembly 304A. The interconnections between and operation of the lift assembly 414 and the second key assembly 304B may be analogous. For example, the lift assembly 414 may be coupled to a portion of the second threaded drive shaft 404B, the second disk 410B, and the second end portion 442B of the second key assembly 304B. The lift assembly 414 may be configured to adjust the tent angle θₜₑₙₜ of the second key assembly 304B relative to the second disk 410B about the tent axis Aₜₑₙₜ₂. The tent axis Aₜₑₙₜ₂ may be substantially parallel to the first end portion 442A of the second key assembly 304B.

In more detail, the second threaded shaft 416B of the lift assembly 414 may be coupled to a portion of a top surface of the second disk 410B.

The second flexible linkage 418B of the lift assembly 414 may be coupled between the second threaded drive shaft 404B and the second threaded shaft 416B. In some embodiments, a second gearbox 444B may couple an end of the second flexible linkage 418B to an end of the second threaded drive shaft 404B. The gearbox 444B may include a 90-degree gearbox or a gearbox of another angle. The second flexible linkage 418B may rotate in response to rotation of the second threaded drive shaft 404B by the electric motor 404. Moreover, rotation of the second flexible linkage 418B may cause the second threaded shaft 416B to rotate. The second flexible linkage 418B may be flexible to allow the transfer of torque from the second threaded drive shaft 404B to the second threaded shaft 416B while accommodating translational movement and/or rotational movement of the second disk 410B relative to the base plate 402.

The fourth movable member 420B of the lift assembly 414 may be coupled to a portion of the second threaded shaft 416B. The fourth movable member 420B may be configured to translate along the second threaded shaft 416B to a lockable position to raise or lower the second end portion 442B of the second key assembly 304B. For example, the fourth movable member 420B may include a nut, analogous to the second movable member 406B, that is configured to translate along the second threaded shaft 416B in response to rotation of the second threaded drive shaft 404B, the second flexible linkage 418B, and the second threaded shaft 416B by the electric motor 404. In these and other embodiments, the second threaded shaft 416B may be coupled to the second disk 410B at opposing ends of the second threaded shaft 416B to allow the fourth movable member 420B to translate substantially along a length of the second threaded shaft 416B.

The second rigid elongate member 422B of the lift assembly 414 may include a first end slidably coupled to a portion of the second threaded shaft 416B and a second end rotatably coupled to a portion of the second end portion 442B of the second key assembly 304B. The second end of the first rigid elongate member 422A may be rotatably coupled to the portion of the second end portion 442B by a ball joint, for example. The first end of the second rigid elongate member 422B slidably coupled to the portion of the second threaded shaft 416B may be configured to translate along the second threaded shaft 416B in response to translation of the fourth movable member 420B along the second threaded shaft 416B.

For instance, when the fourth movable member 420B is adjacent to the first end of the second rigid elongate member 422B, translation of the fourth movable member 420B along the second threaded shaft 416B to the left may force the first end of the second rigid elongate member 422B to also translate to the left. Moreover, the second rigid elongate member 422B may be substantially rigid, the second end of the second rigid elongate member 422B may be rotatably coupled to the second end portion 442B of the second key assembly 304B, and the first end portion 442A of the first key assembly 304A may be rotatably coupled to the second disk 410B. As such, translation of the first end of the second rigid elongate member 422B to the left along the second threaded shaft 416B may cause the second end portion 442B of the second key assembly 304B to be elevated by the tent angle θₜₑₙₜ.

Translation of the fourth movable member 420B along the second threaded shaft 416B to the right may urge translation of the first end of the second rigid elongate member 422B to the right. In some embodiments, a weight of the second key assembly 304B against the second end of the second rigid elongate member 422B may be sufficient to force the second end of the second rigid elongate member 422B downward and the first end of the second rigid elongate member 422B rightward as the fourth movable member 420B translates to the right.

A length of the second rigid elongate member 422B may determine a second tent angle threshold value for the second key assembly 304B. For instance, the greater the length of the second rigid elongate member 422B, the greater the second tent angle threshold value may be for the second key assembly 304B. In these and other embodiments, the second rigid elongate member 422B may include two axially aligned sleeves slidably coupled together or some other suitable configuration. A slidable position of the two axially aligned sleeves may be manually adjustable and/or may be lockable by a stopper member at least partially inserted through one or both of the sleeves to determine the length of the second rigid elongate member 422B.

Modifications, additions, or omissions may be made to the keyboard 300 of FIGS. 4A-4C without departing from the scope of the claimed embodiments. For example, the keyboard 300 of FIGS. 4A-4C may include one more components (not shown) that are configured to control the tilt angle θₜᵢₗₜ (FIG. 3E) of the keyboard 300. Optionally, the tilt angle θₜᵢₗₜ may be controlled independently for each of the first and second segments 302A and 302B and/or for each of the first and second key assemblies 304A and 304B. Moreover, while FIGS. 4A-4C illustrate a single electric motor 404 that drives adjustments to all adjustable parameters (e.g., separation distance d, splay angle θ_{splay}, and tent angle θₜₑₙₜ in the illustrated embodiment), in other embodiments, the keyboard 300 may include multiple electric motors, each of which may drive adjustments to a separate set of adjustable parameters. Alternately or additionally, the keyboard 300 may include wiring and/or electronics associated with receiving and transferring user input from the keyboard 300 to a computer to which the keyboard 300 is communicatively coupled.

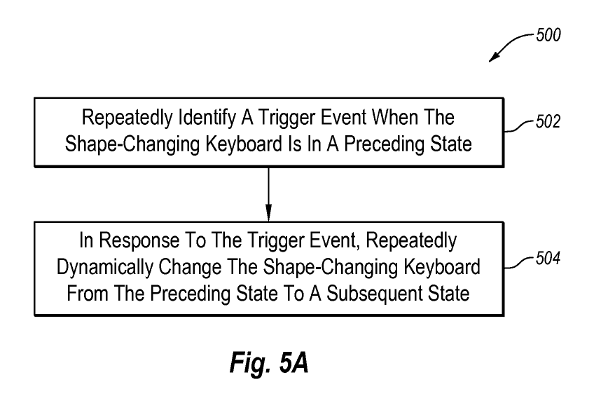

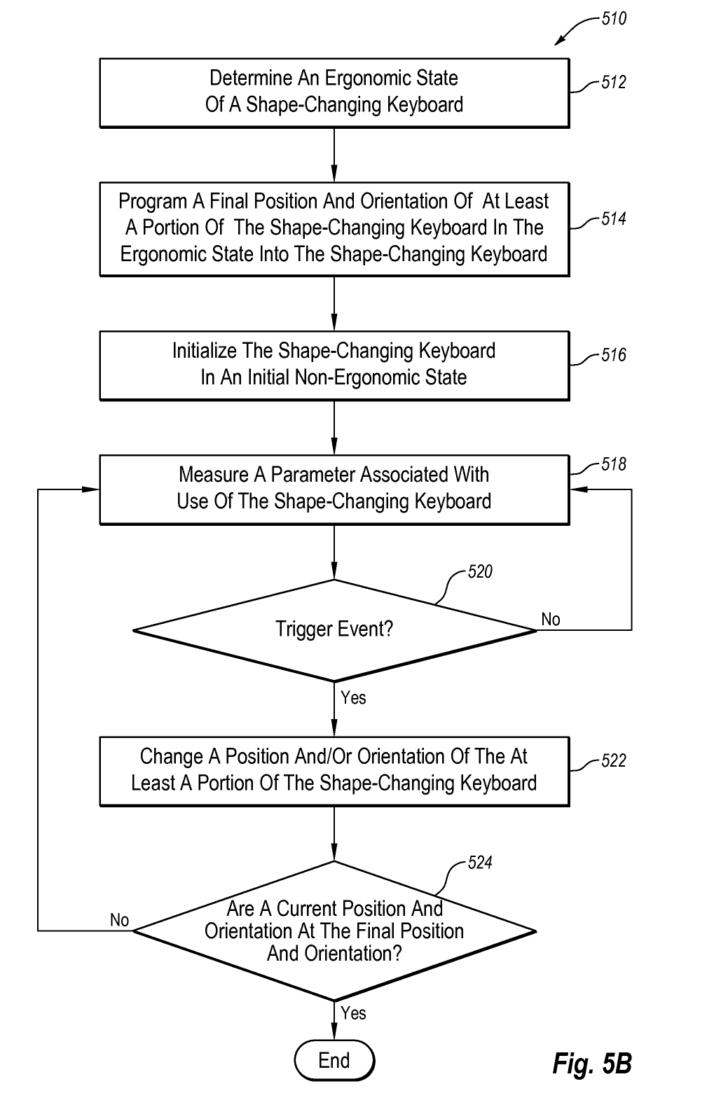

FIG. 5A shows a flow diagram of an example method 500 to transition a shape-changing keyboard from a first state to a second state, arranged in accordance with at least some embodiments described herein. Generally, the second state may include a more ergonomic state than the first state. In the discussion that follows, the first state may be described as an initial non-ergonomic state and the second state may be described as an ergonomic state. More generally, the second state may include any state that is relatively more ergonomic than the first state.

The method 500 may be performed in whole or in part by, e.g., the keyboard 300 of FIGS. 3A-4C or more generally any shape-changing keyboard that includes a first segment, a second segment, and a dynamic adjustment assembly coupled between the first and second segments. Alternately or additionally, the method 500 may be performed and/or controlled by a processor device, such as the processor device 212 or 415 of FIG. 2 or FIGS. 4A-4C, which may be included in the shape-changing keyboard or in a computer to which the shape-changing keyboard is communicatively coupled. An analogous method to transition virtually any device from an initial non-ergonomic (or first) state to an ergonomic (or second) state may be performed in whole or in part by, e.g., the device 212 or 415. The method 500 includes various operations, functions, or actions as illustrated by one or more of blocks 502 and/or 504. The method 500 may begin at block 502.

In block 502 (“Repeatedly Identify A Trigger Event When The Shape-Changing Keyboard Is In A Preceding State”), a trigger event may be repeatedly identified when the shape-changing keyboard is in a preceding state. The preceding state may include the initial non-ergonomic (or first) state or any intermediate state between the initial non-ergonomic (or first) state and the ergonomic (or second) state. The trigger event may include, for example, passage of a particular period of time since a previous trigger event was detected, a performance parameter associated with the shape-changing keyboard being at or above a performance threshold, or physiological data of a user of the shape-changing keyboard satisfying a particular criterion. Block 502 may be followed by block 504.

In block 504 (“In Response To The Trigger Event, Repeatedly Dynamically Change The Shape-Changing Keyboard From The Preceding State To A Subsequent State”), the shape-changing keyboard may be repeatedly changed from the preceding state to a subsequent state in response to the trigger event. The subsequent state may include the ergonomic (or second) state or any intermediate state between the initial non-ergonomic (or first) state and the ergonomic (or second) state. In these and other embodiments, repeatedly identifying the trigger event when the shape-changing keyboard is in the preceding state and repeatedly dynamically changing the shape-changing keyboard from the preceding state to the subsequent state may be effective to change the shape-changing keyboard over time. For example, the shape-changing keyboard may be changed over time from the initial non-ergonomic state to the ergonomic state. Repeatedly dynamically changing the shape-changing keyboard from the preceding state to the subsequent state may include effecting a change over time of a position and/or orientation of at least a portion of one or both of the first and second segments of the shape-changing keyboard.

Effecting a change over time of a position and/or orientation of the at least the portion of one or both of the first and second segments may include changing at least one of: a separation distance between the first and second segments; a splay angle of at least a portion of the first segment; a splay angle of at least a portion of the second segment; a tent angle of the at least the portion of the first segment; a tent angle of the at least the portion of the second segment; a tilt angle of the at least the portion of the first segment; or a tilt angle of the at least the portion of the second segment.

In some embodiments, the method 500 may include a recursive method in which the trigger event is identified when the shape-changing keyboard is in the preceding state followed by, in response to the trigger event, the dynamic change of the shape-changing keyboard from the preceding state to the subsequent state, and then repeating identification of the trigger event and dynamic change of the shape-changing keyboard until the ergonomic state is reached. The method 500 may cycle through the intermediate states between the initial non-ergonomic state and the ergonomic state such that each intermediate state is the subsequent state in a corresponding iteration of the method 500 and is then the previous state in the corresponding next iteration of the method 500.

In some embodiments, repeatedly identifying the trigger event when the shape-changing keyboard is in the preceding state and repeatedly dynamically changing the shape-changing keyboard from the preceding state to the subsequent state may include repeatedly measuring a performance parameter associated with the shape-changing keyboard during use of the shape-changing keyboard; and in response to the performance parameter being at or above a performance threshold, repeatedly effecting an incremental change of the position and/or orientation of the at least a portion of one or both of the first and second segments. The performance parameter may include typing speed, typing accuracy, or other suitable performance parameter, or a combination of multiple performance parameters.

In some embodiments, repeatedly identifying the trigger event when the shape-changing keyboard is in the preceding state and repeatedly dynamically changing the shape-changing keyboard from the preceding state to the subsequent state may include repeatedly tracking a duration of usage time of the shape-changing keyboard that has occurred since a preceding incremental change of a position and/or orientation of the at least a portion of one or both of the first and second segments; and in response to the duration of usage time reaching an adaptation duration, repeatedly effecting an incremental change of the position and/or orientation of the at least a portion of one or both of the first and second segments. In some embodiments, the preceding incremental change from which the duration of usage time is tracked may include an immediately preceding incremental change.

In the above-described embodiments, the performance threshold may include a first performance threshold. In these and other embodiments, the method 500 may further include reversing the preceding incremental change, or one or more preceding incremental changes, in response to the performance parameter dropping below a second performance threshold different from and lower than the first performance threshold. In these and other embodiments, the shape-changing keyboard may be returned to a preceding state where the performance parameter is relatively higher if, e.g., the prior trigger event was a false positive or the user is suffering a temporary setback.

Alternately or additionally, the method 500 may include receiving data indicating a request or command by the user to hold further changes until further notice.

One skilled in the art will appreciate that, for this and other processes and methods disclosed herein, the functions performed in the processes and methods may be implemented in differing order. Furthermore, the outlined operations are only provided as examples, and some of the operations may be optional, combined into fewer operations, supplemented with other operations, or expanded into additional operations without detracting from the essence of the disclosed embodiments.

For example, the method 500 may additionally include receiving a reset input effective to return the shape-changing keyboard to the initial non-ergonomic state.

Alternately or additionally, the method 500 may include, prior to repeatedly identifying the trigger event when the shape-changing keyboard is in the preceding state and repeatedly dynamically changing the shape-changing keyboard from the preceding state to the subsequent state, manually changing the shape-changing keyboard to the ergonomic state; coupling one or more stopper members to the shape-changing keyboard that determine the ergonomic state of the shape-changing keyboard, wherein the positions of the stopper members coincide with the shape-changing keyboard in the ergonomic state; and returning the shape-changing keyboard to the initial non-ergonomic state with the one or more stopper members maintained at the positions that coincide with the shape-changing keyboard in the ergonomic state. In the example of FIGS. 4A-4C, returning the shape-changing keyboard to the initial non-ergonomic (or first) state may include the electric motor 404 rotating in a direction opposite the direction used to transition from the first state to the second state. Alternately or additionally, the user or other person may select which of multiple parameters to return to values associated with the first state.

In this and other embodiments, a user of the shape-changing keyboard may work with a physiotherapist or other entity to manually change the shape-changing keyboard to an ergonomic state that is optimized or customized for the user. While the shape-changing keyboard is in the ergonomic state, the physiotherapist and/or the user may couple one or more stopper members to the shape-changing keyboard that determine the ergonomic state of the shape-changing keyboard. The stopper members may include, for example, the first stopper member 408A, the second stopper member 408B, the first disk stopper member 412A, and/or the second disk stopper member 412B described above. Alternately or additionally, each of the first and second rigid elongate members 422A and 422B may include a manually adjustable length that can be locked by a stopper member such as a detent. As described above, the positions of such stopper members may determine the ergonomic state of the shape-changing keyboard and/or may coincide with the shape-changing keyboard in the ergonomic state. The shape-changing keyboard may be returned to the initial non-ergonomic state with the one or more stopper members maintained at the positions that coincide with the shape-changing keyboard in the ergonomic state. The user may then begin using the shape-changing keyboard in the non-ergonomic state with the shape-changing keyboard undergoing a series of incremental changes until reaching the ergonomic state (e.g., as determined by the stopper members) as already described above.

Alternately or additionally, whether the shape-changing keyboard is in an intermediate state or in the ergonomic state, the method 500 may include adjusting one or more parameters of the shape-changing keyboard in any direction, including towards the ergonomic state or towards the initial non-ergonomic state. If a performance parameter associated with the shape-changing keyboard improves in response to the adjustment or the user indicates a preference for the adjusted state, the shape-changing keyboard may remain at the adjusted state and/or may periodically adjust one or more parameters of the shape-changing keyboard to determine whether the performance parameter continues to improve.

FIG. 5B shows a flow diagram of another example method 510 to transition a shape-changing keyboard from a first state to a second state, arranged in accordance with at least some embodiments described herein. Generally, the second state may include a more ergonomic state than the first state. In the discussion that follows, the first state may be described as an initial non-ergonomic state and the second state may be described as an ergonomic state. More generally, the second state may include any state that is relatively more ergonomic than the first state.

The method 510 may be performed in whole or in part by, e.g., the keyboard 300 of FIGS. 3A-4C or more generally any shape-changing keyboard that includes a first segment, a second segment, and a dynamic adjustment assembly coupled between the first and second segments. Alternately or additionally, the method 510 may be performed and/or controlled by a processor device, such as the processor device 212 or 415 of FIG. 2 or FIGS. 4A-4C, that may be included in the shape-changing keyboard or in a computer to which the shape-changing keyboard is communicatively coupled. An analogous method to transition virtually any device from an initial non-ergonomic (or first) state to an ergonomic (or second) state may be performed in whole or in part by, e.g., the device 212 or 415. The method 510 includes various operations, functions, or actions as illustrated by one or more of blocks 512, 514, 516, 518, 520, 522, and/or 524. The method 510 may begin at block 512.

In block 512 (“Determine An Ergonomic State Of A Shape-Changing Keyboard”), an ergonomic (or second) state of a shape-changing keyboard may be determined. The ergonomic (or second) state may be optimized or customized for a user. The ergonomic (or second) state may be determined by a computer or processor device or by a physiotherapist or other entity. The ergonomic (or second) state may include or be associated with a final position and orientation of at least a portion of the shape-changing keyboard in the ergonomic (or second) state. Block 512 may be followed by block 514.

In block 514 (“Program A Final Position And Orientation Of At Least A Portion Of The Shape-Changing Keyboard In The Ergonomic State Into The Shape-Changing Keyboard”), the final position and orientation of the at least the portion of the shape-changing keyboard may be programmed into the shape-changing keyboard. The final position and orientation may be programmed into the shape-changing keyboard by, e.g., manually changing the shape-changing keyboard to the ergonomic (or second) state and coupling one or more stopper members to the shape-changing keyboard that determine the ergonomic (or second) state of the shape-changing keyboard. Alternately or additionally, the final position and orientation may be programmed into the shape changing keyboard by storing parameters that describe the final position and orientation in non-volatile memory or other non-transitory computer-readable medium. Block 514 may be followed by block 516.

In block 516 (“Initialize the Shape-Changing Keyboard In An Initial Non-Ergonomic State”), the shape-changing keyboard may be initialized in an initial non-ergonomic (or first) state to begin use of the shape-changing keyboard. Initializing the shape-changing keyboard in the initial non-ergonomic (or first) state to begin use may include returning the shape-changing keyboard to the initial non-ergonomic (or first) state with the one or more stopper members maintained at the positions that coincide with the shape-changing keyboard in the ergonomic (or second) state. Alternately or additionally, initializing the shape-changing keyboard in the initial non-ergonomic (or first) state to begin use may include initializing the shape-changing keyboard in the initial non-ergonomic (or first) state with the final position and orientation being programmed into the shape-changing keyboard. Block 516 may be followed by block 518.

In block 518 (“Measure A Parameter Associated With Use Of The Shape-Changing Keyboard”), a parameter associated with use of the shape-changing keyboard may be measured. The parameter may include a duration of usage time of the shape-changing keyboard, a performance parameter as already described herein, a physiological parameter of the user as measured by an EMG sensor or other physiological sensor, or other parameter. Block 518 may be followed by block 520.

In block 520 (“Trigger Event?”), it may be determined if a trigger event is detected based on the parameter. Determining if a trigger event is detected may include identifying a trigger event as described elsewhere herein. If a trigger event is not detected (“No” at block 520), the method 510 may return to block 518. Otherwise, block 520 may be followed by block 522 (“Yes” at block 520).

In block 522 (“Change A Position And/Or Orientation Of The At Least A Portion Of The Shape-Changing Keyboard”), if it is determined that a trigger event is detected at block 520, a position and/or orientation of the at least a portion of the shape-changing keyboard may be changed. The change may include an incremental change. Alternately or additionally, the change may include a change of at least one of: a separation distance between first and second segments of the shape-changing keyboard; a splay angle of at least a portion of the first segment; a splay angle of at least a portion of the second segment; a tent angle of the at least the portion of the first segment; a tent angle of the at least the portion of the second segment; a tilt angle of the at least the portion of the first segment; or a tilt angle of the at least the portion of the second segment. Block 522 may be followed by block 524.

At block 524 (“Are A Current Position And Orientation At The Final Position And Orientation?”), it may be determined whether a current position and orientation of the at least the portion of the shape-changing keyboard are at the final position and orientation of the ergonomic (or second) state. The determination may be made by a computer or processor device comparing the current position and orientation to the final position and orientation. Alternately or additionally, the determination may be made by a dynamic adjustment assembly included in the shape-changing keyboard. For instance, an electric motor or other component of the dynamic adjustment assembly may determine that the current position and orientation are at the final position and orientation if a resistance for further movement by the electronic device is above a threshold level of force or torque. If the current position and orientation are determined not to be at the final position and orientation (“No” at block 524), the method 510 may return to block 518. If the current position and orientation are determined to be at the final position and orientation (“Yes” at block 524), the method 510 may end.

The method 510 may include or be combined with the method 500 of FIG. 5A. Alternately or additionally, the method 510 may include one or more additional operations such as one or more operations described with respect to FIG. 5A or elsewhere herein.

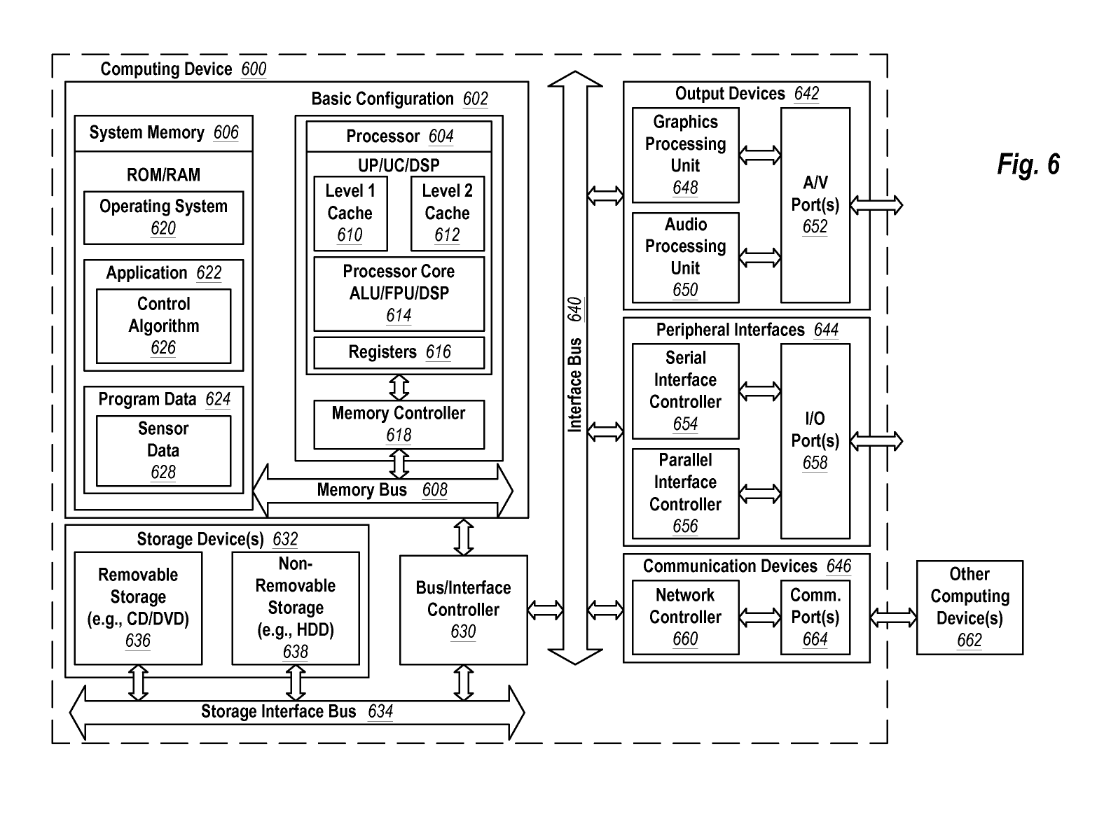

FIG. 6 is a block diagram illustrating an example computing device 600 that is arranged for transitioning a device from a first state to a second state, arranged in accordance with at least some embodiments described herein. Generally, the second state may include a more ergonomic state than the first state. In the discussion that follows, the first state may be described as an initial non-ergonomic state and the second state may be described as an ergonomic state. More generally, the second state may include any state that is relatively more ergonomic than the first state. The device that is transitioned from the first state to the second state may include the device 200 and/or the shape-changing keyboard 300 described herein. Alternately or additionally, the device may include first and second segments and a dynamic adjustment assembly coupled therebetween. The device may be communicatively coupled to the computing device 600. In a very basic configuration 602, the computing device 600 typically includes one or more processors 604 and a system memory 606. A memory bus 608 may be used for communicating between the processor 604 and the system memory 606.

Depending on the desired configuration, the processor 604 may be of any type including, but not limited to, a microprocessor (IP), a microcontroller (μC), a digital signal processor (DSP), or any combination thereof. The processor 604 may include one more levels of caching, such as a level one cache 610 and a level two cache 612, a processor core 614, and registers 616. An example of the processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including, but not limited to, volatile memory (such as RAM), non-volatile memory (such as ROM, flash memory, etc.), or any combination thereof. The system memory 606 may include an operating system 620, one or more applications 622, and program data 624. The application 622 may include a control algorithm 626 that is arranged to control automatic changes to a position and/or orientation of at least a portion of one or both of the first and second segments of the device. The program data 624 may include sensor data 628 that may be useful for controlling automatic changes to the position and/or orientation of the at least a portion of one or both of the first and second segments of the device as is described herein. In some embodiments, the application 622 may be arranged to operate with the program data 624 on the operating system 620 such that the dynamic adjustment assembly of the device may be controlled to control automatic changes to the position and/or orientation of the at least a portion of one or both of the first and second segments of the device based on the sensor data indicating identifiable trigger events as is described herein. The processor 604 and/or the system memory 606 may be provided on the device with the first and second segments. Alternately or additionally, the processor 604 may correspond to the processor device 212 of FIG. 2.

The computing device 600 may have additional features or functionality, and additional interfaces to facilitate communications between the basic configuration 602 and any required devices and interfaces. For example, a bus/interface controller 630 may be used to facilitate communications between the basic configuration 602 and one or more data storage devices 632 via a storage interface bus 634. The data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

The system memory 606, the removable storage devices 636, and the non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., output devices 642, peripheral interfaces 644, and communication devices 646) to the basic configuration 602 via the bus/interface controller 630. The example output devices 642 include a graphics processing unit 648 and an audio processing unit 650, which may be configured to communicate to various external devices such as a display or speakers via one or more A/V ports 652. The example peripheral interfaces 644 include a serial interface controller 654 or a parallel interface controller 656, which may be configured to communicate with external devices such as input devices (e.g., keyboard, mouse, pen, voice input device, touch input device, etc.), sensors such as the sensor 114 of FIG. 1, or other peripheral devices (e.g., printer, scanner, etc.) via one or more I/O ports 658. An example of the communication devices 646 includes a network controller 660, which may be arranged to facilitate communications with one or more other computing devices 662 over a network communication link via one or more communication ports 664.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media as used herein may include both storage media and communication media.

The computing device 600 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 600 may also be implemented as a personal computer including both laptop computer and non-laptop computer configurations, or as a device with an initial non-ergonomic state and an ergonomic state configured to be transitioned over time from the initial non-ergonomic state to the ergonomic state as described herein.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A shape-changing keyboard comprising:
a first segment;
a second segment; and
a dynamic adjustment assembly coupled between the first and second segments and that includes an electric motor, wherein the dynamic adjustment assembly is configured to change the shape-changing keyboard from a first state to a second state by repeated change over time of a position and/or orientation of at least a portion of one or both of the first and second segments and wherein the second state is a more ergonomic state than the first state.

2. The shape-changing keyboard of claim 1, further comprising a reset mechanism operably coupled to at least one of the first segment, the second segment, and the dynamic adjustment assembly, wherein the shape-changing keyboard is configured to be returned to the first state in response to actuation of the reset mechanism.

3. The shape-changing keyboard of claim 1, wherein the change of the shape-changing keyboard is controlled by a feedback loop executed by a processor device communicatively coupled to the dynamic adjustment assembly and wherein the processor device is configured to:
repeatedly measure a performance parameter that includes at least one of a typing accuracy or a typing speed during use of the shape-changing keyboard; and
in response to the performance parameter being above a performance threshold, repeatedly operate the dynamic adjustment assembly to effect an incremental change of the position and/or orientation of the at least the portion of one or both of the first and second segments.

4. The shape-changing keyboard of claim 1, further comprising a processor device communicatively coupled to the dynamic adjustment assembly, wherein the change of the shape-changing keyboard is controlled by a feedback loop executed by the processor device and wherein the processor device is configured to:
repeatedly measure a performance parameter that includes at least one of a typing accuracy or a typing speed during use of the shape-changing keyboard; and
in response to the performance parameter being above a performance threshold, repeatedly operate the dynamic adjustment assembly to effect an incremental change of the position and/or orientation of the at least the portion of one or both of the first and second segments.

5. The shape-changing keyboard of claim 1, wherein the first segment comprises a first lower housing and the dynamic adjustment assembly comprises:
a base plate slidably coupled to both a portion of the first lower housing and a portion of a second lower housing, wherein the electric motor is coupled to a portion of the base plate and wherein the electric motor includes a first threaded drive shaft that extends from a first side of the electric motor;
a first movable member threadably coupled to a portion of the first threaded drive shaft, wherein the first movable member is configured to translate along the first threaded drive shaft in response to rotation of the first threaded drive shaft by the electric motor; and
a first stopper member coupled to another portion of the first lower housing in a translation path of the first movable member.

6. The shape-changing keyboard of claim 5, wherein the second segment comprises the second lower housing and the dynamic adjustment assembly further comprises:
a second threaded drive shaft that extends from a second side of the electric motor that is opposite the first side, wherein the second threaded drive shaft is coaxial with the first threaded drive shaft;
a second movable member threadably coupled to a portion of the second threaded drive shaft, wherein the second movable member is configured to translate along the second threaded drive shaft in response to rotation of the second threaded drive shaft by the electric motor; and
a second stopper member coupled to another portion of the second lower housing in a translation path of the second movable member,
wherein in the first state of the shape-changing keyboard, a separation distance between the first and second segments is at a first separation distance threshold value, and in the second state of the shape-changing keyboard, the separation distance between the first and second segments is at a second separation distance threshold value determined by a position of the first stopper member with respect to the first lower housing and a position of the second stopper member with respect to the second lower housing.

7. The shape-changing keyboard of claim 6, wherein:
the another portion of the first lower housing to which the first stopper member is coupled defines an adjustment slot within which the first stopper member is manually movable with respect to the first lower housing; and
the another portion of the second lower housing to which the second stopper member is coupled defines an adjustment slot within which the second stopper member is manually movable with respect to the second lower housing.

8. The shape-changing keyboard of claim 5, wherein:
the first segment further comprises a first key assembly including a multiple number of keys; and
the dynamic adjustment assembly further comprises:
a first disk rotatably coupled to a different portion of the first lower housing, wherein the first disk is rotatable about a disk axis substantially normal to a lower surface of the first lower housing and wherein the first disk includes a radial slot that extends radially outward at least partially between a center and a perimeter of the first disk; and
a first disk stopper member coupled to another portion of the base plate, wherein the first disk stopper member extends upward through the radial slot of the first disk;
the first key assembly is coupled to a portion of the first disk;
in the first state of the shape-changing keyboard, a splay angle of the first disk about the disk axis is at a first splay angle threshold value; and
in the second state of the shape-changing keyboard, the splay angle of the first disk about the disk axis is at a second splay angle threshold value determined by a position of the first disk stopper member with respect to the first lower housing.

9. The shape-changing keyboard of claim 8, wherein the another portion of the base plate to which the first disk stopper member is coupled defines an adjustment slot within which the first disk stopper member is manually movable.

10. The shape-changing keyboard of claim 8, wherein:
the first key assembly includes a first end portion and a second end portion opposite the first end portion;
the first key assembly is rotatably coupled along a portion of the first end portion to another portion of the first disk;
the dynamic adjustment assembly further comprises a lift assembly coupled to a portion of the first threaded drive shaft of the electric motor, the first disk, and the second end portion of the first key assembly, wherein the lift assembly is configured to adjust a tent angle of the first key assembly relative to the first disk about a tent axis parallel to the first end portion of the first key assembly.

11. The shape-changing keyboard of claim 10, wherein the lift assembly comprises:
a first threaded shaft coupled to a portion of a top surface of the first disk;
a first flexible linkage coupled between the first threaded drive shaft and the first threaded shaft;
a third movable member coupled to a portion of the first threaded shaft, wherein the third movable member is configured to translate along the first threaded shaft in response to rotation of the first threaded drive shaft, the first flexible linkage, and the first threaded shaft by the electric motor; and
a first rigid elongate member that includes a first end slidably coupled to another portion of the first threaded shaft and a second end rotatably coupled to a portion of the second end portion of the first key assembly, wherein:
in the first state of the shape-changing keyboard, the tent angle of the first key assembly relative to the first disk about the tent axis parallel to the first end portion of the first key assembly is at a first tent angle threshold value; and
in the second state of the shape-changing keyboard, the tent angle of the first key assembly relative to the first disk about the tent axis parallel to the first end portion of the first key assembly is at a second tent angle threshold value determined by a length of the first rigid elongate member.

12. The shape-changing keyboard of claim 11, wherein the first rigid elongate member comprises two axially aligned sleeves slidably coupled together and wherein a slidable position of the two axially aligned sleeves with respect to each other is manually adjustable and determines the length of the first rigid elongate member.

13. A method to transition a shape-changing keyboard from a first state to a second state that is a more ergonomic state than the first state, the method comprising:
repeatedly identifying a trigger event when the shape-changing keyboard is in a preceding state and wherein the shape-changing keyboard includes a first segment and a second segment; and
in response to the trigger event, repeatedly dynamically changing the shape-changing keyboard from the preceding state to a subsequent state;
wherein repeatedly identifying the trigger event when the shape-changing keyboard is in the preceding state and repeatedly dynamically changing the shape-changing keyboard from the preceding state to the subsequent state are effective to change over time the shape-changing keyboard from the first state to the second state, including effecting a change over time of a position and/or orientation of at least a portion of one or both of the first and second segments.

14. The method of claim 13, further comprising, prior to repeatedly identifying the trigger event when the shape-changing keyboard is in the preceding state and repeatedly dynamically changing the shape-changing keyboard from the preceding state to the subsequent state:
manually changing the shape-changing keyboard to the second state;
coupling one or more stopper members to the shape-changing keyboard that determine the second state of the shape-changing keyboard, wherein a position of each of the one or more stopper members coincides with the shape-changing keyboard in the second state; and
returning the shape-changing keyboard to the first state with the one or more stopper members maintained at the positions that coincide with the shape-changing keyboard in the second state.

15. The method of claim 13, wherein repeatedly identifying the trigger event when the shape-changing keyboard is in the preceding state and repeatedly dynamically changing the shape-changing keyboard from the preceding state to the subsequent state comprises:
repeatedly measuring a performance parameter associated with the shape-changing keyboard during use of the shape-changing keyboard; and
in response to the performance parameter being above a performance threshold, repeatedly effecting an incremental change of the position and/or orientation of the at least the portion of one or both of the first and second segments.

16. The method of claim 13, wherein repeatedly identifying the trigger event when the shape-changing keyboard is in the preceding state and repeatedly dynamically changing the shape-changing keyboard from the preceding state to the subsequent state comprises:
repeatedly tracking a duration of usage time of the shape-changing keyboard that has occurred since a preceding incremental change of the position and/or orientation of the at least the portion of one or both of the first and second segments; and
in response to the duration of usage time reaching an adaptation duration, repeatedly effecting an incremental change of the position and/or orientation of the at least the portion of one or both of the first and second segments.

17. The method of claim 13, wherein effecting the change over time of the position and/or orientation of the at least the portion of one or both of the first and second segments comprises changing at least one of:
a separation distance between the first and second segments;
a splay angle of at least a portion of the first segment;
a splay angle of at least a portion of the second segment;
a tent angle of the at least the portion of the first segment;
a tent angle of the at least the portion of the second segment;
a tilt angle of the at least the portion of the first segment; or
a tilt angle of the at least the portion of the second segment.

18. The method of claim 14, further comprising receiving a reset input effective to return the shape-changing keyboard to the first state.

19. A non-transitory computer-readable medium having stored thereon computer-readable instructions, which in response to execution by a processor device, cause the processor device to perform or control performance of operations to transition a shape-changing keyboard from a first state to a second state that is a more ergonomic state than the first state, the operations comprising:
repeatedly identifying a trigger event when the shape-changing keyboard is in a preceding state and wherein the shape-changing keyboard includes a first segment and a second segment; and
in response to the trigger event, repeatedly dynamically changing the shape-changing keyboard from the preceding state to a subsequent state;
wherein repeatedly identifying the trigger event when the shape-changing keyboard is in the preceding state and repeatedly dynamically changing the shape-changing keyboard from the preceding state to the subsequent state are effective to change over time the shape-changing keyboard from the first state to the second state, including effecting a change over time of a position and/or orientation of at least a portion of one or both of the first and second segments.

20. The non-transitory computer-readable medium of claim 19, wherein repeatedly identifying the trigger event when the shape-changing keyboard is in the preceding state and repeatedly dynamically changing the shape-changing keyboard from the preceding state to the subsequent state comprises:
repeatedly measuring a performance parameter associated with the shape-changing keyboard during use of the shape-changing keyboard; and
in response to the performance parameter being above a performance threshold, repeatedly effecting an incremental change of the position and/or orientation of the at least the portion of one or both of the first and second segments.

21. The non-transitory computer-readable medium of claim 19, wherein repeatedly identifying the trigger event when the shape-changing keyboard is in the preceding state and repeatedly dynamically changing the shape-changing keyboard from the preceding state to the subsequent state comprises:
repeatedly tracking a duration of usage time of the shape-changing keyboard that has occurred since a preceding incremental change of the position and/or orientation of the at least the portion of one or both of the first and second segments; and
in response to the duration of usage time reaching an adaptation duration, repeatedly effecting an incremental change of the position and/or orientation of the at least the portion of one or both of the first and second segments.

22. The non-transitory computer-readable medium of claim 19, wherein effecting the change over time of the position and/or orientation of the at least the portion of one or both of the first and second segments comprises changing at least one of:
a separation distance between the first and second segments;
a splay angle of at least a portion of the first segment;
a splay angle of at least a portion of the second segment;
a tent angle of the at least the portion of the first segment;
a tent angle of the at least the portion of the second segment;
a tilt angle of the at least the portion of the first segment; or
a tilt angle of the at least the portion of the second segment.

23. The non-transitory computer-readable medium of claim 19, wherein the operations further comprise receiving a reset input effective to return the shape-changing keyboard to the first state.
